(19) United States
(12) Patent Application Publication
(10) Pub. No.: US 2021/0097062 A1
(43) Pub. Date: Apr. 1, 2021

(54) SYSTEM AND METHOD FOR GENERATING DYNAMIC VISUALIZATIONS AND NARRATIONS OF DIGITAL DATA

(71) Applicants: VIVEK MISHRA, Lucknow (IN); NEERAV PAREKH, Mumbai (IN); NISARG BAVISHI, Mumbai (IN); ROMIL SHAH, Mumbai (IN); NAKUL SAI ADAPALA, Bantumilli (IN)

(72) Inventors: VIVEK MISHRA, Lucknow (IN); NEERAV PAREKH, Mumbai (IN); NISARG BAVISHI, Mumbai (IN); ROMIL SHAH, Mumbai (IN); NAKUL SAI ADAPALA, Bantumilli (IN)

(21) Appl. No.: 16/676,449

(22) Filed: Nov. 7, 2019

(30) Foreign Application Priority Data
Sep. 26, 2019 (IN) 201921038881

(51) Int. Cl. G06F 16/23; G06F 16/25; G06N 20/00

(52) U.S. Cl. CPC G06F 16/2393; G06N 20/00; G06F 16/258

(57) ABSTRACT

Exemplary embodiments of the present disclosure are directed towards a system for generating dynamic visualizations and narrations of digital data, comprising: a computing device comprises a dynamic data visualization and narration module, whereby the dynamic data visualization and narration module comprises a metadata extraction module configured to process the digital data on the computing device, an insight generator configured to filter out all unwanted weightages based on the data's domain, a reducer configured to take account of user inputs and weights generated at that point by a preference engine and the reducer also configured to take the account of user inputs and the reducer is configured to decide which insight is relevant enough to be shown to the user, visualizations generated on the computing device based on dynamic factors or features of the data and patterns in the data on which the insight is formed.

### TECHNICAL FIELD

The disclosed subject matter relates generally to systems and computer implemented methods for generating visualizations and narrations. More particularly, the present disclosure relates to a system and method for dynamically generating visualizations and narrations by interpreting digital data.

### BACKGROUND

In this digital age, rise of data analysis has generated a great deal of excitement in connection with data analytics. Massive amount of data is present in data analytics systems and there is an assumption that new visualizations to draw insights and information will be available to analysts that were previously unavailable. However, in practice, the visualizations are not available and the analysts need to interpret the insights based on available visualizations. Further to interpret the data, the analysts need expertise and time failing which the insights are not completely understood.

Existing data analytics systems provide graphical representations and spreadsheets, but it is difficult for people to understand such representations. Despite all the powerful analytics systems that are in use to gather and process data, many companies still rely to manually process, screen and to glean most important information from the data. Existing solutions have difficulty in finding something interesting and meaningful within the data and communicating same to a user. The existing solutions fail to assist the companies to communicate the data insights to the users in an easy to understand format.

In the light of the aforementioned discussion, there exists a need for a certain system with novel methodologies that would overcome the above-mentioned challenges.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards dynamically generating narratives by interpreting real-time digital data and explaining the dynamically generated visualizations.

Another objective of the present disclosure is directed towards ensuring everyone get the same information, even with/without any prior knowledge about the data.

Another objective of the present disclosure is directed towards gleaning relevant insights for each individual user by leveraging past user actions or user profiles by generating the language such that every insight seems connected to a central theme/story and personalized at scale.

Another objective of the present disclosure is directed towards applying data functions to any data source to perform a few operations before using the data for running analysis. The few operations may include, but not limited to, making new columns based on few columns present in the dataset, changing name of the data column, and so forth, smart binning and partitioning of data into clusters for further analysis.

Another objective of the present disclosure is directed towards processing digital data which may be of any size by using a data meta extractor technique and then using the output results for further calculations in a way to capture all relevant features of the entire data.

Another objective of the present disclosure is directed towards a smart framework configured to add, maintain and update the contents of a graph network database.

Another objective of the present disclosure is directed towards deploying learning methods to self-update knowledge base in real time from live streaming sources and also learn from any unstructured data sources.

Another objective of the present disclosure is directed towards using transfer learning to add a new domain in the knowledge base. Also one-shot learning methods are employed for updating knowledge base with minimal efforts for training a new domain.

Another objective of the present disclosure is directed towards collecting weightages from the knowledge base and user's selection as inputs along with the metadata extractor techniques.

Another objective of the present disclosure is directed towards figuring out relevant data patterns to generate insights based on the weightages at a specific point of time.

Another objective of the present disclosure is directed towards updating attributes based on the basis of reward based learning when the user likes something and selects it, to save it for future reference.

Exemplary embodiments of the system comprising a computing device comprises a dynamic data visualization and narration module, the dynamic data visualization and narration module comprises at least one first database configured to hold digital data to run analysis and a metadata extraction module configured to process the digital data on the computing device.

According to an exemplary aspect of the present disclosure, the system comprising an insight generator configured to take a plurality of weightages from a second database and the user selections as the input along with the aggregated data, the insight generator also configured to filter out all unwanted weightages based on the data's domain and uses the remaining data to generate a plurality insights from the data on the computing device.

According to another exemplary aspect of the present disclosure, the system further comprising a preference engine configured to store session information of the user, along with the Data profile as well as the user's own profile and also generates a new set of weights which is used to decide what the user is likely to find the most relevant and useful.

According to another exemplary aspect of the present disclosure, the system further comprising a reducer configured to take account of user inputs and weights generated at that point by the preference engine and the reducer also configured to take the account of user inputs and a combination of a component called “Preference” and the reducer is configured to decide which insight is relevant enough to be shown to the user based on a plurality of parameters, a plurality of visualizations generated on the computing device based on a plurality of dynamic factors or features of the data and a plurality of patterns in the data on which the insight is formed.

### BRIEF DESCRIPTION OF THE DRAWINGS

FIG. 1 is a block diagram depicting a schematic representation of a system for generating dynamic visualizations and narrations of digital data, in accordance with one or more exemplary embodiments.

FIG. 2 is a block diagram depicting the dynamic data visualization and narration module 106 shown in FIG. 1, in accordance with one or more exemplary embodiments.

FIG. 3 is an example diagram depicting the sales record data screen, in accordance with one or more exemplary embodiments.

FIG. 4 is an example diagram depicting the dashboard screen, in accordance with one or more exemplary embodiments.

FIG. 5A is an example diagram depicting the pie chart visualization screen, in accordance with one or more exemplary embodiments.

FIG. 5B is an example diagram depicting an exemplary market share of order ID contribution by region pie chart visualization screen, in accordance with one or more exemplary embodiments.

FIG. 5C is an example diagram depicting an exemplary market share of order ID contribution by country pie chart visualization screen, in accordance with one or more exemplary embodiments.

FIG. 5D is an example diagram depicting an exemplary market share of order ID contribution by sales channel pie chart visualization screen, in accordance with one or more exemplary embodiments.

FIG. 5E is an example diagram depicting an exemplary market share of order ID contribution by order priority pie chart visualization screen, in accordance with one or more exemplary embodiments.

FIG. 5F is an example diagram depicting an exemplary market share of order ID contribution by weekday (order date) pie chart visualization screen, in accordance with one or more exemplary embodiments.

FIG. 5G is an example diagram depicting an exemplary market share of order ID contribution by weekday (ship date) pie chart visualization screen, in accordance with one or more exemplary embodiments.

FIG. 6 is an example diagram depicting an exemplary graph screen, in accordance with one or more exemplary embodiments.

FIG. 7A is an example diagram depicting another exemplary graph screen, in accordance with one or more exemplary embodiments.

FIG. 7B is an example diagram depicting another exemplary graph screen, in accordance with one or more exemplary embodiments.

FIG. 7C is an example diagram depicting another exemplary graph screen, in accordance with one or more exemplary embodiments.

FIG. 7D is an example diagram depicting another exemplary graph screen, in accordance with one or more exemplary embodiments.

FIG. 7E is an example diagram depicting another exemplary graph screen, in accordance with one or more exemplary embodiments.

FIG. 7F is an example diagram depicting another exemplary graph screen, in accordance with one or more exemplary embodiments.

FIG. 7G is an example diagram depicting another exemplary graph screen, in accordance with one or more exemplary embodiments.

FIG. 7H is an example diagram depicting another exemplary graph screen, in accordance with one or more exemplary embodiments.

FIG. 7I is an example diagram depicting another exemplary graph screen, in accordance with one or more exemplary embodiments.

FIG. 7J is an example diagram depicting another exemplary graph screen, in accordance with one or more exemplary embodiments.

FIG. 8 is a flow diagram depicting a method for generating dynamic visualizations and narrations of digital data, in accordance with one or more exemplary embodiments.

FIG. 9 is a flow diagram depicting a method for updating components of the insight generator in real time on the computing device, in accordance with one or more exemplary embodiments.

FIG. 10 is a flow diagram depicting a method for continuously updating the collected knowledge in the second database on the computing device, in accordance with one or more exemplary embodiments.

FIG. 11 is a flow diagram depicting a method for making the output most ideal for the user in the current timeframe on the computing device, in accordance with one or more exemplary embodiments.

FIG. 12 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

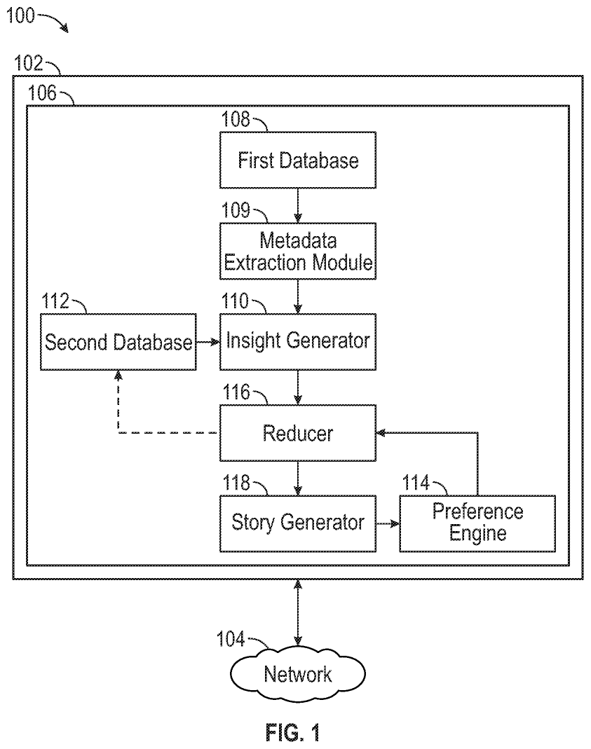

Referring to FIG. 1 is a block diagram 100 depicting a schematic representation of an environment for generating dynamic visualizations and narrations of digital data, in accordance with one or more exemplary embodiments. The environment 100 includes a computing device 102, a network 104, and a dynamic data visualization and narration module 106. The computing device 102 may be connected to the one or more computing devices via the network 104. The network 104 may include but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 104 may be configured to provide access to different types of users. The computing device 102 may include, but are not limited to, a personal digital assistant, smart phones, personal computers, a mobile station, computing tablets, a handheld device, an internet enabled calling device, an internet enabled calling software, a telephone, a mobile phone, a digital processing system, and so forth.

The system 100 has the capability to auto trigger some action based on the variance in the data and push notifications to multiple communication channels like emails, messages, and so forth. Here the variance in the data includes a significant change in some data parameter happening in the current data. Significance may be defined by the second database 112 and all learning of different domains that is acquired overtime. For example, a change of 20% in a product type for a retailer might not be of any significance but a similar 20% change in the Finance domain may be alarming. The system 100 may figure out this significant change when such a case occurs it may push notifications to any of the communication channels which may be configured to user's need.

Although the computing device 102 is shown in FIG. 1, an embodiment of the system 100 may support any number of computing devices. The computing device 102 may be operated by a user. The user may include, but not limited to, a company, an organization, a firm, a customer, a person, a consumer, a client, an employee, and so forth. The computing device 102 supported by the environment 100 is realized as a computer-implemented or computer-based device having the hardware or firmware, software, and/or processing logic needed to carry out the computer-implemented methodologies described in more detail herein. The dynamic data visualization and narration module 106 may include a first database 108, a second database 112, a metadata extraction module 109, an insight generator 110, a preference engine 114, a reducer 116, and a story generator 118. The first database 108 may be configured to hold digital data to run analysis. The digital data may include, but not limited to, business data, learned data, metadata, mining data, user data, and so forth. The digital data which may be of any size is then processed by a metadata extraction module 109 on the computing device 102. The metadata extraction module 109, is accessed as a mobile application, web application, software that offers the functionality of accessing mobile applications, and viewing/processing of interactive pages. Results from the metadata extraction module 109 may be used for calculations and are designed in a way that they capture all relevant features of the entire digital data on the computing device 102.

The use of metadata extraction module 109 significantly decreases the time on the computing device 102 to generate any insight. Based upon user interactions, weightages in the metadata extraction module 109 may be updated. Users may also leverage the custom feature builder option to create new features by using a set of pre-build techniques. Input digital data to the insight generator 110 may be the data source the user wants to work on and some additional user inputs about what the user wants to focus on from the data. The user inputs may not necessary for the insight generator 110, but their presence may help the insight generator 110 to show more relevant and precise insights. Multiple data sources may be physically coupled to the insight generator 110 or at a remote location connected via the network 104 on which the insight generator 110 may work.

The dynamic data visualization and narration module 106 further includes a second database 112. The second database 112 may be represented as a knowledge base database. The output of the second database 112 may be a set of weightages formed on all the knowledge gathered which may then be used by the insight generator 110 to obtain insights from user's digital data. Transfer learning and one-shot learning techniques are implemented to add a new domain in the second database 112 with minimal efforts in training for the new domain.

The insight generator 110 may be configured to take weightages from the second database 112, and the user selections as the inputs along with the aggregated data. The insight generator 110 may be configured to filter out all unwanted weightages based on the data's domain and then uses the remaining data to generate the insights from the data. The insight generator 110 may be configured to figure out relevant data patterns which may be used to generate insights on the basis of the weightages at that specific point in time thereby helping generate better visualizations and narratives. The visualizations may include, but not limited to, pie charts, bar graphs, line graphs, Cartesian graphs, pictographs, tables, charts, and so forth. The narratives may include, but not limited to, one or more sentences, text corresponding to visualizations, visualization block text, and so forth.

The preference engine 114 may be a self-learning database or a collection of weights like the second database 112, but unlike the second database 112 which may be the same across the users and domains, the contents of the preference engine 114 may change basis the domain (or the data) and the user. The preference engine 114 may be configured to store session information of the user (which is basically the user actions while the user is using the tool), along with the Data Profile as well as the User's own profile. The preference engine 114 may further be configured to generate a new set of weights which may be used to decide what the user is likely to find the most relevant and useful. The set of weights may be tailored to a specific user and data so no further filtering is needed. Also, with each run basis, the preference engine 114 inputs the user actions data and keeps updating to make the output the most ideal for the specific user in the current timeframe.

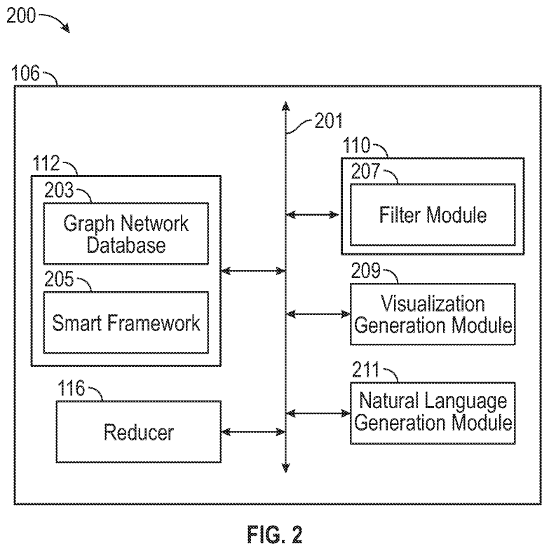

The reducer 116 may be configured to take account of user inputs and weights generated at that point by the preference engine 114. For example, the reducer 116 is configured to take the account of user inputs and a combination of a component called “Preference”. All the insights generated by the insights generator 110 may not be relevant to the user at this point in time. Where the reducer 116 may be configured to decide which insight is relevant enough to be shown to the user based on the parameters such as the account of user inputs and weights. This relevance may also be defined as the possibility of the insight to help the user gain some useful knowledge about the data. The reducer 116 can take into account the level of granularity that the user wants at that particular point via an input as well. Visualizations may be generated based on a lot of dynamic factors or features of the data and the patterns in the data on which the insight is formed. The most appropriate representation for each insight may be chosen from a lot of options based on all the above criterions. For each graph/representation generated a corresponding narrative may also be generated by a natural language generation module 211 (shown in FIG. 2) which explains the findings of that insights.

Once all the available information ready to be shown to the user, a story generator 118 may be configured to decide which insight follows another based on data profile and user profile. When insights need to be clubbed together and also how to appropriately change their language to make it look like a single insight. Finally, the dynamic data visualization and narration module 106 is configured to show the blocks or individual insights as an output to the user with the help of some visual representation and narratives on the computing device 102. When the user likes something and selects it, to save it for future reference, the dynamic data visualization and narration module 106 updates a lot of attributes on the basis of reward based learning techniques. The first aspect of the dynamic data visualization and narration module 106 which gets updated by the user action is the priorities given to the aggregated data, as the more an insight generated from a particular aggregation is picked, its weights may be updated accordingly. Also, all the components of the preference engine 114 get updated as it stores user's session information. And lastly, feedback provides back to the story generator 118 which then updates the way it generates the flow and connects insights.

Referring to FIG. 2 is a block diagram 200 depicting the dynamic data visualization and narration module 106 shown in FIG. 1, in accordance with one or more exemplary embodiments. The dynamic data visualization and narration module 106 includes a bus 201, the second database 112, the insight generator 110, the reducer 116, and the preference engine 114. The second database 112 may include a graph network database 203, and a smart framework 205. The smart framework 205 may be configured to add, maintain and update the contents of the graph network database 203. The graph network database 203 may include all worldly information which relates to any domain or any event. Online learning methods may be deployed to update the second database 112 in real time from live streaming sources, and may also learn from any unstructured data sources such as news website, social media sites, any third party websites, and so forth. All the collected knowledge in the second database 112 may be continuously updated by the smart framework 205 by learning over any or all the data sources simultaneously. The bus 201 may include a path that permits communication among the modules of the dynamic data visualization and narration module 106 installed on the computing device 102. The term “module” is used broadly herein and refers generally to a program resident in the memory of the computing device 102.

The insight generator 110 may include a filter module 207 configured to filter out all the unwanted weightages and then uses the remaining data to generate insights from the data. The filter module 207 may also be configured to figure out relevant patterns in the data which may be used to generate the insight on the basis of the weightages at that specific point in time. Based on the weightages the patterns which may be important at that time may keep on changing which will give more relevant insights helping generate better visualizations and narratives. The dynamic data visualization and narration module 106 further includes visualization generation module 209 configured to generate visualizations basis a lot of dynamic factors of features of the data and on the basis the patterns in the data on which the insight is formed. The visualization generation module 209 may be configured to use the output of the reducer 116 to generate visualizations and appropriate narratives. The output of the reducer 116 may include, but not limited to, user relevant insights, and the like. The most appropriate representation for each insight may be chosen from a lot of options based on all the above criterions. The dynamic data visualization and narration module 106 also includes a natural language generation module 211 configured to generate narrative for each graph/representation/visualization which explains the findings of the insights.

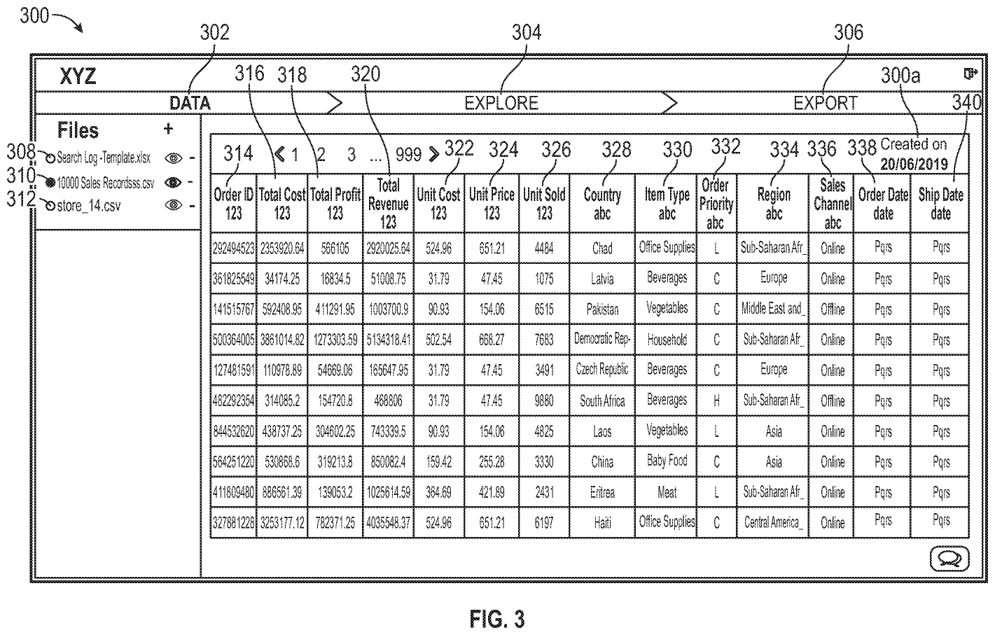

Referring to FIG. 3 is an example diagram 300 depicting the sales record data screen, in accordance with one or more exemplary embodiments. The dynamic data visualization and narration module 106 may be configured to enable the user on the computing devices 102 to login or signup by using a user's login identity credentials. The identity credentials comprise a unique identifier (e.g., a username, an email address, a date of birth, a house address, a mobile number, and the like), and a secured code (e.g., a password, a symmetric encryption key, biometric values, a passphrase, and the like). The sales record data screen 300 includes a data option 302, an explore option 304, an export option 306, a search log icon 308, a sales record icon 310, and a store icon 312. If the user selects the data option 302, then the sales record data screen 300 depicts the search log option 308, the sales record option 310, and the store option 312. On selecting a sales record file from the sales record option 310, the sales record data screen 300a depicts an order id option 314, a total cost option 316, a total profit option 318, a total revenue option 320, a unit cost option 322, a unit price option 324, a unit sold option 326, a country option 328, an item type option 330, an order priority option 332, a region option 334, a sales channel option 336, an order date option 338, and a ship date option 340.

The order id option 314 may include the order id of the particular item and/or service. The item and/or service may include, but not limited to, beverages, vegetables, household appliances, food, meat, cereal, office supplies, and so forth. The total cost option 316 may include over-all cost of number of units. The units may include, but not limited to total number of items and/or services, and so forth. The total profit option 318 may include total profits acquired on the items and/or services. The total revenue option 320 may include the total revenue on the items and/or services. The unit cost option 322 may include the unit cost of the items and/or services. The unit price option 324 may include the unit price of the items and/or the services. The unit sold option 326 may include the total number of units sold. The country option 328 may include county of the particular order id. The item type option 330 may include the particular category of the item and/or service. The order priority option 332 may include the priority of the order of the particular order id. The region option 334 may include the order received from the particular region with the particular order id. The regions may include, but not limited to, Europe, Australia, North America, Asia, Central America, Middle East, sub-sharan Africa, Pakistan, china, South Africa, Loas, Haiti, Latvia, and so forth. The sales channel option 336 may include online or offline. The sales channel option 336 represents whether the sales channel is online or offline. The order date option 338 may include the date of the order received. The ship date option 340 may include the shipment date of the received order.

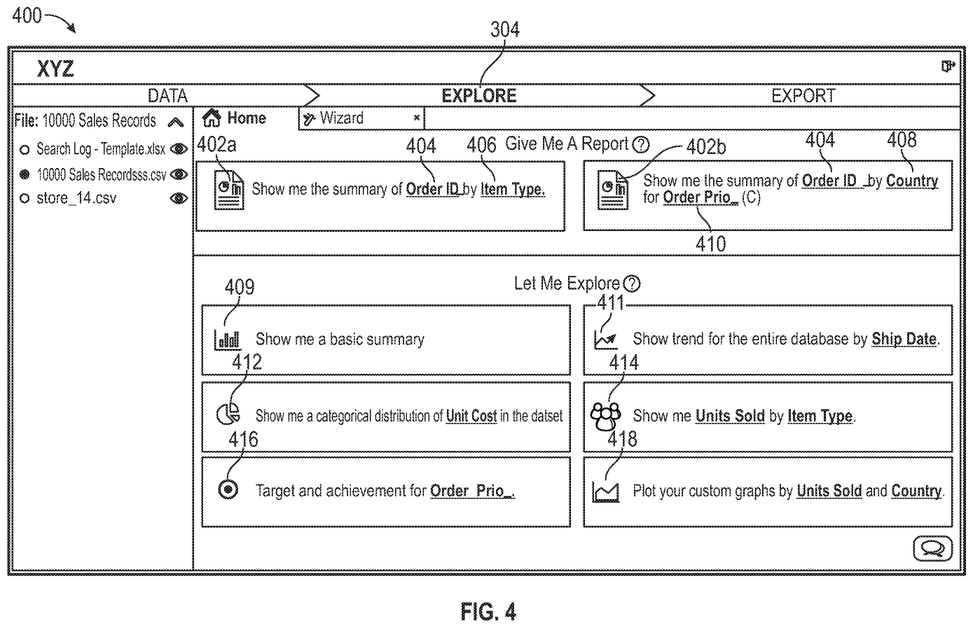

Referring to FIG. 4 is an example diagram 400 depicting the dashboard screen, in accordance with one or more exemplary embodiments. On selecting the explore option 304, the dashboard screen 400 depicts a first summary option 402a and a second summary option 402b. The first summary option 402a may include an order ID option 404, and an item type option 406. The first summary option 402a may be configured to depict the summary of order ID by the item type. The order ID option 404 may include a drop-down menu configured to depict the number of options such as an order ID, total revenue, total cost, total profit, unit cost, unit price, units sold, and so forth. The item type option 406 may include a drop-down menu configured to depict the number of options such as country, item type, order priority, sales channel, and so forth.

The second summary option 402b may include the order ID option 404, a country option 408, and an order priority option 410. The second summary option 402b may be configured to depict the summary of order ID by the country for order priority. The dashboard screen 400 further includes a basic summary icon 409, a trend icon 411, a categorical distribution icon 412, a show me icon 414, target and achievement icon 416, and a graph icon 418. If the user selects the basic summary icon 409, then frequency charts may be displayed on the computing device 102. The frequency charts may include, but not limited to, region type frequency charts, item type frequency charts, sales channel frequency charts, order priority frequency charts, order date frequency charts, ship date frequency charts, and so forth. If the user selects the trend icon 410, then trend graphs for the entire dataset by the ship date or order date may be displayed on the computing device 102. The trend graphs may include, but not limited to, monthly trend of order id graph, monthly contribution % of order id, monthly trend of units sold, monthly contribution % of units sold, monthly trend of unit price, monthly contribution % of unit price, monthly trend of unit cost, monthly contribution % of unit cost, monthly trend of total revenue, monthly contribution % of total revenue, monthly trend of total cost, monthly contribution % of total cost, monthly trend of total profit, monthly contribution % of total profit, and so forth.

The categorical distribution icon 412 may be configured to depict the categorical distribution of at least one of order ID; total revenue; total cost; total profit; unit cost; unit price; units sold; in the dataset. If the user selects at least one option from the list of options such as the order ID option, total revenue option, total cost option, total profit option, unit cost option, unit price option, units sold option, then pie charts may be displayed on the computing device 102. The pie charts may include, but not limited to, order id contribution by region, order id contribution by country, order id contribution by item type, order id contribution by sales channel, order id contribution by order priority, order id contribution by weekday (order date), order id contribution by weekday (ship date), total cost contribution by region, total cost contribution by country, total cost contribution by item type, total cost contribution by sales channel, total cost contribution by order priority, total cost contribution by weekday (order date), total cost contribution by weekday (ship date), unit cost contribution by region, unit cost contribution by country, unit cost contribution by item type, unit cost contribution by sales channel, unit cost contribution by order priority, unit cost contribution by weekday (order date), unit cost contribution by weekday (ship date), total profit contribution by region, total profit contribution by country, total profit contribution by item type, total profit contribution by sales channel, total profit contribution by order priority, total profit contribution by weekday (order date), total profit contribution by weekday (ship date), total revenue contribution by region, total revenue contribution by country, total revenue contribution by item type, total revenue contribution by sales channel, total revenue contribution by order priority, total revenue contribution by weekday (order date), total revenue contribution by weekday (ship date), unit price contribution by region, unit price contribution by country, unit price contribution by item type, unit price contribution by sales channel, unit price contribution by order priority, unit price contribution by weekday (order date), unit price contribution by weekday (ship date), unit sold contribution by region, unit sold contribution by country, unit sold contribution by item type, unit sold contribution by sales channel, unit sold contribution by order priority, unit sold contribution by weekday (order date), unit sold contribution by weekday (ship date), and so forth.

The show me icon 414 may be configured to depict at least one of order ID; total revenue; total cost; total profit; unit cost; unit price; units sold in the dataset and also at least one of: country, item type, order priority, region, sales channel in the dataset. If the user selects at least one option from the first list of options such as the order ID option, total revenue option, total cost option, total profit option, unit cost option, unit price option, units sold option, along with the at least one option from the second list of options such as country option, item type option, order priority option, region option, sales channel option, then visualizations may be displayed on the computing device 102. The visualizations may include, but not limited to, contribution summary of order id by country, country(s) driving overall decline of order id—in current period, 12 country(s) below the average order id, periodic movement of order id per country, country(s) with the highest order id, country(s) with the lowest order id, year on year comparison of order id between one month and another month, monthly trend of order id, contribution summary of total cost by item type, item type(s) driving overall decline of total cost—in current period, 8 item type(s) below the average total cost, periodic movement of total cost per item type, item type(s) with the highest total cost, item type(s) with the lowest total cost, absolute total cost v/s % percent contribution, item type(s) with the biggest gains and losses in total cost—in current period, year on year comparison of total cost between one month and another month, monthly trend of total cost, contribution summary of total profit by order priority, order priority(s) driving overall decline of total profit—in current period, 2 order priority(s) below the average total profit, periodic movement of total profit per order priority, order priority(s) with the highest total profit, order priority(s) with the lowest total profit, absolute total profit v/s % percent contribution, year on year comparison of total profit between one month and another month, monthly trend of total profit, order priority(s) with the most identical trend of total profit compared to overall trend for all order priority(s), contribution summary of total revenue by region, region(s) driving overall decline of total revenue—in current period, 3 region(s) below the average total revenue, periodic movement of total revenue per region, region(s) with the highest total revenue, region(s) with the lowest total revenue, region(s) with the biggest gains and losses in total revenue—in current period, region(s) with the biggest gains and losses in total revenue—in current period, year on year comparison of total revenue between one month and another month, monthly trend of total revenue, region(s) with the most identical trend of total revenue compared to overall trend for all region(s), contribution summary of unit cost by sales channel, sales channel(s) driving overall decline of unit cost—in current period, 1 sales channel(s) below the average unit cost, periodic movement of unit cost per sales channel, absolute unit cost v/s % percent contribution, year on year comparison of unit cost between one month and another month, monthly trend of unit cost, sales channel(s) with the most identical trend of unit cost compared to overall trend for all sales channel(s), and so forth.

The target and achievement icon 416 may be configured to depict target and achievement for at least one of: country, item type, order priority, region, sales channel, and so forth. The target and achievement icon 416 may also be configured to enable the user to replace one option with another option. If the user selects at least one option from the list of options such as the country, item type, order priority, region, sales channel, then the list of options may be displayed on the computing device 102. The list of options may include, but not limited to, target achievement option, central entity option, value entity option, and so forth. The custom graph icon 418 may be configured to depict the custom graphs by selecting at least one of order ID; total cost; total profit; total revenue; unit cost; unit price; units sold in the dataset and also at least one of: country, item type, order priority, region, sales channel in the dataset. The custom graph icon 418 may also be configured to enable the user to replace one option with another option. If the user selects at least one option from the first list of options such as the order ID option, total cost option, total profit option, total revenue option, unit cost option, unit price option, units sold option, along with the at least one option from the second list of options such as country option, item type option, order priority option, region option, sales channel option, then graphs may be displayed on the computing device 102. The custom graphs may include, but not limited to, country-sum (order id), item type-sum (total cost), order priority-sum (total profit), region-sum (total revenue), sales channel-sum (unit cost), country-sum (unit price), item type-sum (units sold), country-sum (total cost), and so forth.

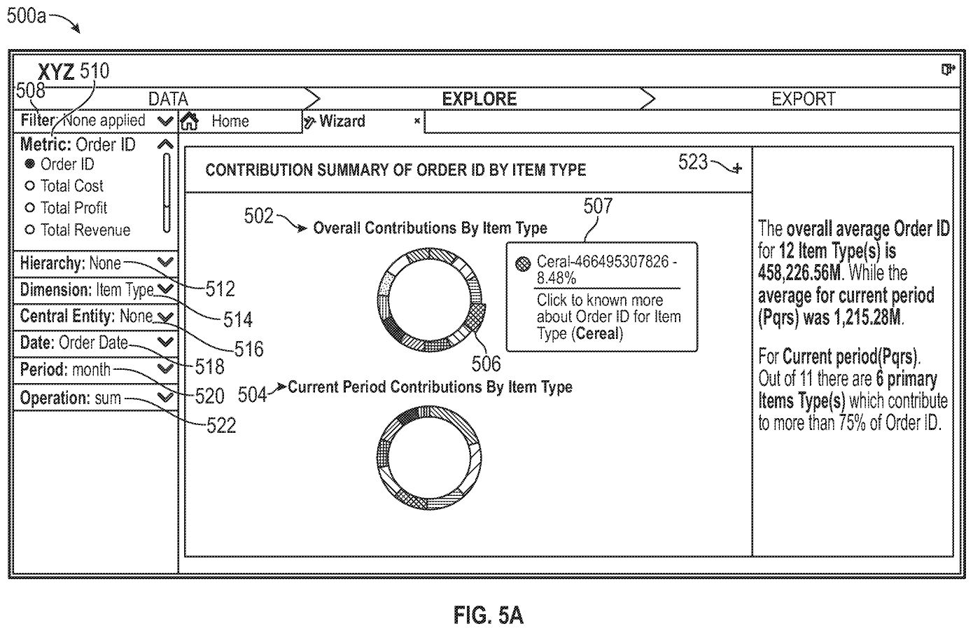

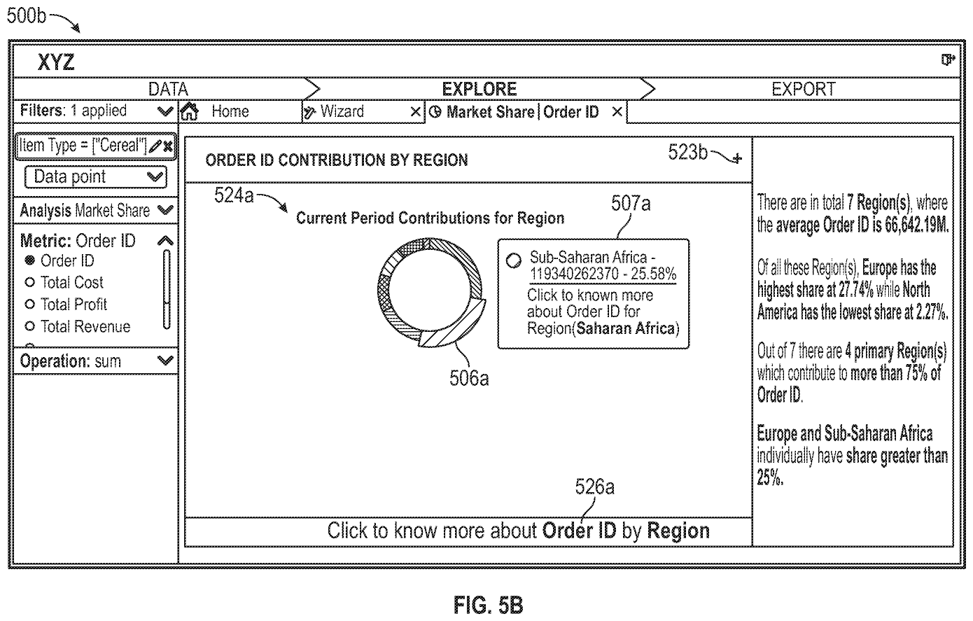

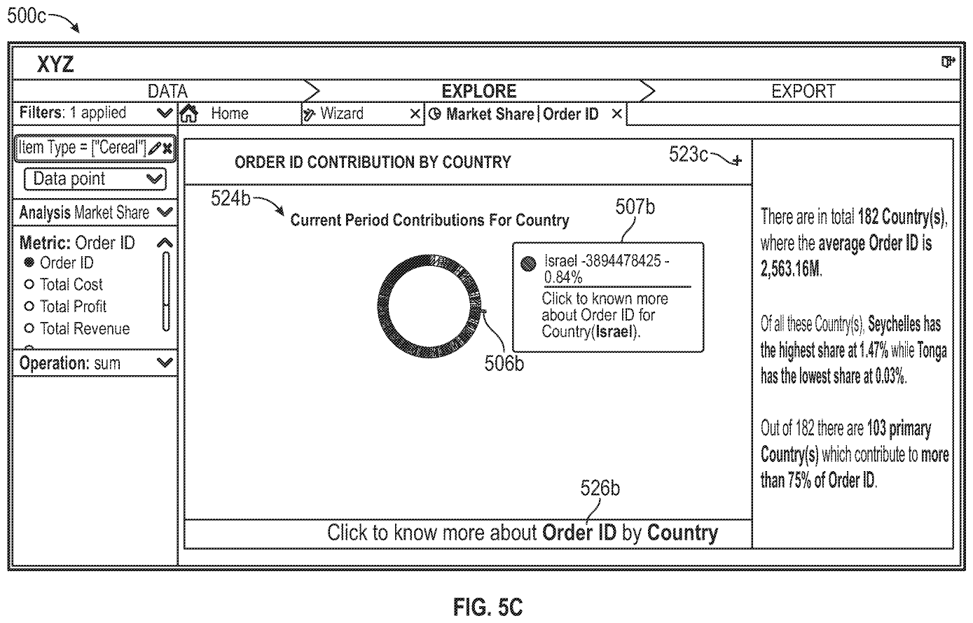

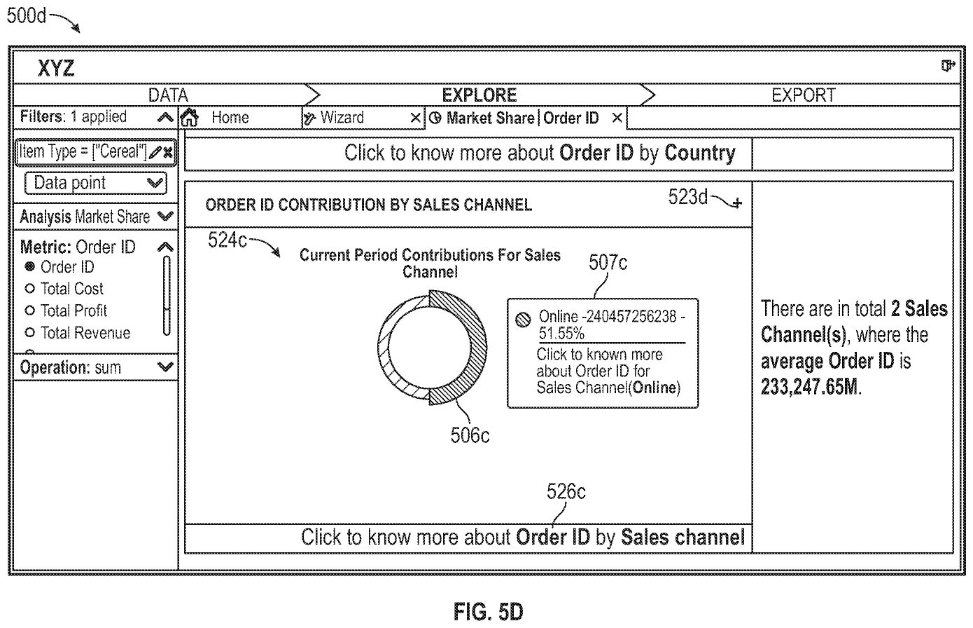

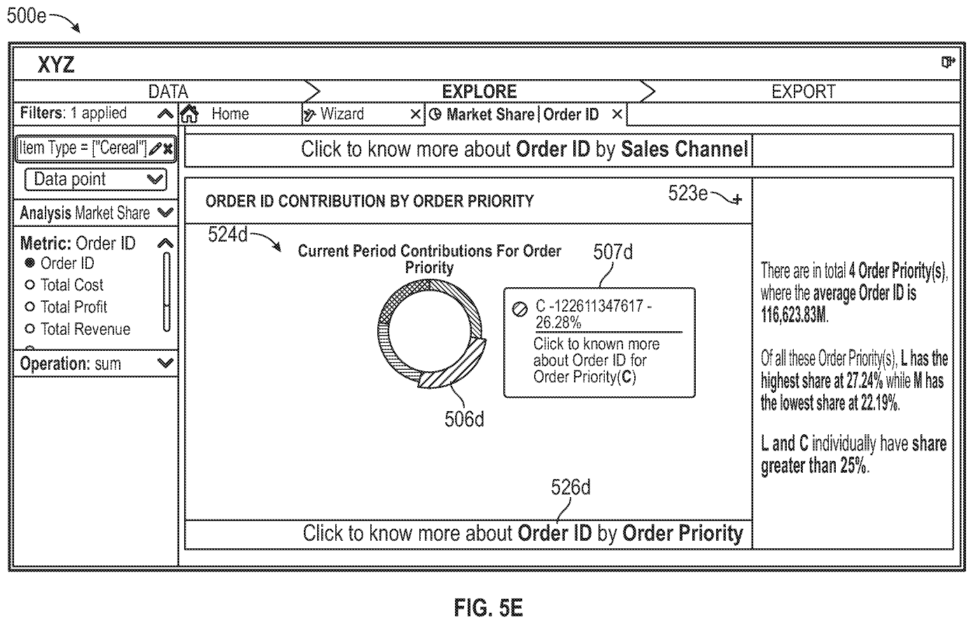

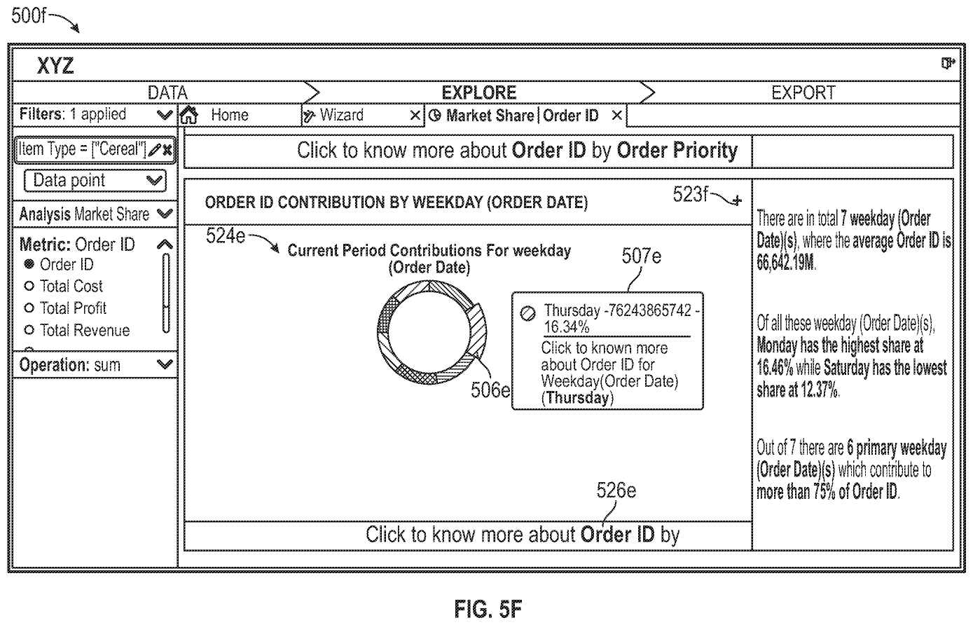

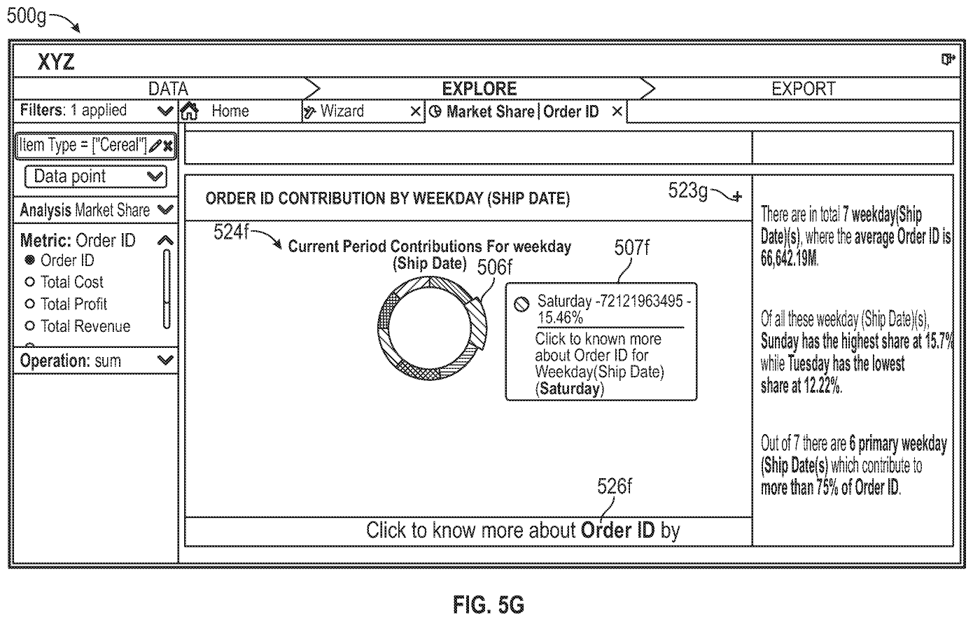

Referring to FIG. 5A is an example diagram 500a depicting the pie chart visualization screen, in accordance with one or more exemplary embodiments. The pie chart visualization 500 may include the contribution summary of order id by item type. On selecting the first summary option 402, the pie chart visualization screen 500 depicts an overall contribution by item type pie chart 502, current period contributions by item type pie chart 504, a highlighted segment 506, a filter option 508, a metric option 510, a hierarchy option 512, a dimension option 514, a central entity 516, a date option 518, a period option 520, an operation option 522, and an export card option 523. The overall contribution by item type pie chart 502 may include the contribution of each item in each segment. For example, the overall average order id for 12 item type(s) is 458,226.56 m, while the average for the current period is 1,141.22 m. The highlighted segment 506 may be configured to depict the screen 507. The screen 507 may include order id for the cereal item. If the user selects the highlighted segment 506, then market share pie chart visualizations may be displayed on the computing device 102. The market share pie chart visualizations may have a drilldown view for the item type cereal as shown in FIG. 5A to FIG. 5F. The drilldown view may allow the user to leverage user preference and learn over it to give more meaningful insights by changing the weightages coming in to the insight generator 110. The current period contributions by item type pie chart 504 may include the current period of items of order ID. The filter option 508 may include a data point configured to enable the user to select at least one of: a country; an item type; an order priority; a region; a sales channel; an order id; a total cost; a total profit; a total revenue; a unit cost; a unit price; units sold; an order date; and a ship date. The metric option 510 may include an order Id, a total cost, a total profit, a total revenue, a unit cost, a unit price, and units sold. The pie chart visualization screen 500 may include, for example, the overall average Order ID for 12 Item Type(s) is 458,226.56M. While the average for current period (Pqrs) was 1,215.28M. For Current period (Pqrs). Out of 11, there are 6 primary Items Type(s) which contribute to more than 75% of Order ID.

The hierarchy option 512 may include options such as country, item type, order priority, region, total cost, total profit, total revenue, unit cost, unit price, unit sold, and so forth. Dimension option 514 may include options such as country, item type, order priority, region, sales channel, and so forth. The central entity option 516 may include options such as country, item type, order priority, region, sales channel, and so forth. The date option 518 may include options such as order date, ship date, and so forth. The period option 520 may include options such as day, week, month, quarter, year, and so forth. The operation option 522 may include options such as sum, mean, count, max, min, and so forth. If the user selects the export card option 523, then the pie chart visualization screen 500 may be emphasized on the computing device 102 and then the export option 306 displays the pie chart visualization screen 500 separately on the computing device 102.

Referring to FIG. 5B is an example diagram 500b depicting an exemplary market share of order ID contribution by region pie chart visualization screen, in accordance with one or more exemplary embodiments. The market share of order ID contribution by region pie chart visualization screen 500b includes a current period contributions for region pie chart 524a, the highlighted segment 506a, and an order ID icon 526a. The current period contribution for region pie chart 524a may include segments for order ID contribution by region (for example, Asia, Europe, America, Australia, and so forth). The highlighted segment 506a may be configured to depict the screen 507a which includes sub-Saharan Africa-order ID and share percentage. The highlighted segment 506a may also be configured to display the overall contributions for region on the computing device 102. For example, Europe and Sub-Saharan Africa individually have share greater than 25%. If the user selects the order ID icon 526a, then category wise visualizations may be displayed on the computing device 102. The category wise visualizations may include, but not limited to, contribution summary of order id by region, region(s) driving overall decline of order id—in current period (dec-WXYZ), 1 region(s) below the average order id, periodic movement of order id per region, region(s) with the highest order id, region(s) with the lowest order id, absolute order id v/s % percent contribution, year on year comparison of order id between (nov-PQRS to dec-PQRS) and (nov-WXYZ to dec-WXYZ), monthly trend of order id, and so forth. The market share of order ID contribution by region pie chart visualization screen 500b may include total Region(s), where the average Order ID is 66,642.19M. Of all these Region(s), Europe has the highest share at 27.74% while North America has the lowest share at 2.27%. Out of 7 there are 4 primary Region(s) which contribute to more than 75% of Order ID. Europe and Sub-Saharan Africa individually have a share greater than 25%.

Referring to FIG. 5C is an example diagram 500c depicting an exemplary market share of order ID contribution by country pie chart visualization screen, in accordance with one or more exemplary embodiments. The market share of order ID contribution by country pie chart visualization screen 500c includes the current period's contributions for country pie chart 524b, the highlighted segment 506b, and an order ID icon 526b. The current period contribution for country pie chart 524b may include segments for order ID contribution by country (for example, Israel, Moldova, Togo, Cuba, Zambia, Algeria, Ukraine, Ethiopia, Swaziland, and so forth). The highlighted segment 506b may be configured to depict the screen 507b which includes order ID and percentage of share. The highlighted segment 506b may also be configured to display the overall contributions for country. If the user selects the order ID icon 526b, then the category wise visualizations may be displayed on the computing device 102. The category wise visualizations may include, but not limited to, overall contributions for country, current period contributions for country, ranks for country (movement of country), comparison between country (for example, better/worse performer), general trend, and so forth. The market share of order ID contribution by country pie chart visualization screen 500c includes total number of countries, where the average Order ID is 2,563.16M. Of all these Country(s), Seychelles has the highest share at 1.47% while Tonga has the lowest share at 0.03%. Out of 182 there are 103 primary Country(s) which contribute to more than 75% of Order ID.

Referring to FIG. 5D is an example diagram 500d depicting an exemplary market share of order ID contribution by sales channel pie chart visualization screen, in accordance with one or more exemplary embodiments. The market share of order ID contribution by sales channel pie chart visualization screen 500d includes the current period's contributions for sales channel pie chart 524c, the highlighted segment 506c, and the order ID icon 526c. The current period contributions for sales channel pie chart 524c may include segments which are an offline channel and an online channel. The highlighted segment 506c may be configured to depict the screen 507c which includes order ID and percentage of share. The highlighted segment 506c may also be configured to display the overall contributions for sales channel. If the user selects the order ID icon 526c, then the category wise visualizations may be displayed on the computing device 102. The category wise visualizations may include, but not limited to, overall contributions by sales channel, current period contributions by sales channel, sales channel(s) driving overall decline of order id—in current period (dec-WXYZ), periodic movement of order id per sales channel, year on year comparison of order id, monthly trend of order id, and so forth. The market share of order ID contribution by sales channel pie chart visualization screen 500d includes total 2 Sales Channel(s), where the average Order ID is 233,247.65M.

Referring to FIG. 5E is an example diagram 500e depicting an exemplary market share of order ID contribution by order priority pie chart visualization screen, in accordance with one or more exemplary embodiments. The market share of order ID contribution by order priority pie chart visualization screen 500e includes the current period's contributions for order priority pie chart 524d, the highlighted segment 506d, and the order ID icon 526d. The current period's contributions for order priority pie chart 524d may include segments which are order priorities. The highlighted segment 506d may be configured to depict the screen 507d which includes order ID and percentage of share. The highlighted segment 506d may also be configured to display the overall contributions for order priority. If the user selects the order ID icon 526d, then the category wise visualizations may be displayed on the computing device 102. The category wise visualizations may include, but not limited to, overall contributions by order priority, current period contributions by order priority, order priority(s) driving overall decline of order ID, order priority(s) below the average order ID, periodic movement of order ID per order priority, order priority(s) with highest order ID, order priority(s) with the lowest order ID, absolute order ID v/s % percent contribution, year on year comparison of order id, monthly trend of order id, and so forth. The market share of order ID contribution by order priority pie chart visualization screen 500e includes total 4 Order Priority(s), where the average Order ID is 116,623.83M. Of all these Order Priority(s), L has the highest share at 27.24% while M has the lowest share at 22.19%. L and C individually have share greater than 25%.

Referring to FIG. 5F is an example diagram 500f depicting an exemplary market share of order ID contribution by weekday (order date) pie chart visualization screen, in accordance with one or more exemplary embodiments. The market share of order ID contribution by weekday (order date) pie chart visualization screen 500f includes the current period's contributions for weekday (order date) pie chart 524e, the highlighted segment 506e, and the order ID icon 526e. The current period's contributions for weekday (order date) pie chart 524e may include segments which are days. The highlighted segment 506e may be configured to depict the screen 507e which includes order ID and percentage of share. The highlighted segment 506e may also be configured to display the important dimension options, central entity options, and so forth. The important dimension options and central entity options may include, but not limited to, country, item type, order priority, sales channel, total cost, total profit, total revenue, unit cost, unit price, and so forth. If the user selects the order ID icon 526e, then the category wise visualizations may be displayed on the computing device 102. The category wise visualizations may include, but not limited to, overall contribution for item type, movement of item type, general trend for item type, and so forth. The market share of order ID contribution by weekday (order date) pie chart visualization screen 500f includes total 7 weekday (Order Date) (s), where the average Order ID is 66,642.19M. Of all these weekday (Order Date) (s), Monday has the highest share at 16.46% while Saturday has the lowest share at 12.37%. Out of 7 there are 6 primary weekday (Order Date)(s) which contribute to more than 75% of Order ID.

Referring to FIG. 5G is an example diagram 500g depicting an exemplary market share of order ID contribution by weekday (ship date) pie chart visualization screen, in accordance with one or more exemplary embodiments. The market share of order ID contribution by weekday (ship date) pie chart visualization screen 500g includes the current period's contributions for weekday (ship date) pie chart 524f, the highlighted segment 506f, and the order ID icon 526f. The current period's contributions for weekday (order date) pie chart 524f may include segments which are days. The highlighted segment 506f may be configured to depict the screen 507f which includes order ID and percentage of share. The highlighted segment 506f may also be configured to display the important dimension options, central entity options, and so forth. The important dimension options and central entity options may include, but not limited to, country, item type, order priority, sales channel, total cost, total profit, total revenue, unit cost, unit price, and so forth. If the user selects the order ID icon 526e, then the category wise visualizations may be displayed on the computing device 102. The category wise visualizations may include, but not limited to, overall contribution for item type, movement of item type, general trend for item type, and so forth. The market share of order ID contribution by weekday (ship date) pie chart visualization screen 500f includes total 7 weekday (Ship Date)(s), where the average Order ID is 66,642.19M. Of all these weekday (Ship Date) (s), Sunday has the highest share at 15.7% while Tuesday has the lowest share at 12.22%. Out of 7 there are 6 primary weekday (Ship Date)(s) which contribute to more than 75% of Order ID.

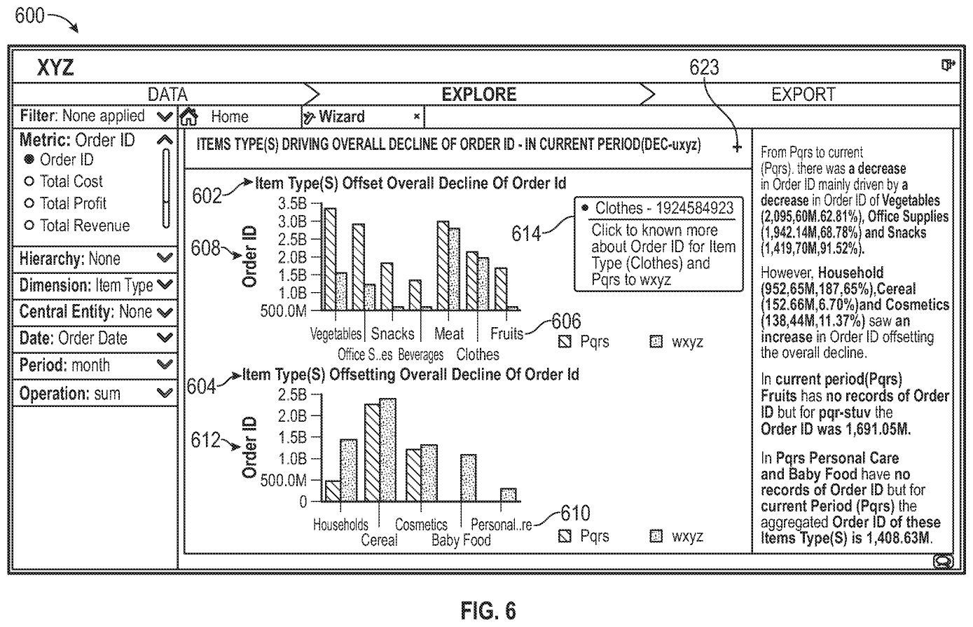

Referring to FIG. 6 is an example diagram 600 depicting an exemplary graph screen, in accordance with one or more exemplary embodiments. The exemplary graph screen 600 may include an item type(s) driving overall the decline of order id graph 602, an item type(s) offsetting overall decline of order id graph 604, which serves as an example of the system being able to auto find reasons for an event in this the overall decline of order id and an export card option 623. The item type driving overall decline of order Id graph 602 may include items 606 on X-axis and order ids 608 on Y-axis. The items may include, but not limited to, vegetables, snacks, beverages, meat, clothes, fruits, and so forth. The order ids may include, but not limited to, 0, 500.0M, 1.0B, 1.5B, 2.0B, 2.5B, 3.0B, 3.5B, and so forth. The item type offsetting overall decline of order Id 604 may include the items 610 on X-axis and the order ids 612 on Y-axis. The items 610 may include, but not limited to, household, cereal, cosmetics, baby food, personal, and so forth. The order ids may include, but not limited to, 0, 500.0M, 1.0B, 1.5B, 2.0B, 2.5B, and so forth. The exemplary screen 614 may be displayed on the computing device 102 after moving the mouse bar on any vertical bar. The vertical bar represents the items on the item type driving overall decline of order Id graph 602. Market share pie chart visualizations may be displayed on the computing device 102 on selecting at least one vertical bar. The market share pie chart visualizations may have a drilldown view for the item type. The drilldown view may allow the user to leverage user preference and learn over it to give more meaningful insights by changing the weightages coming in to the insight generator 110. The exemplary screen 614 may include order id for clothes item. If the user selects the export card option 623, then the exemplary graph screen 600 may be emphasized on the computing device 102 and then the export option 306 displays the exemplary graph screen 600 separately on the computing device 102. The exemplary graph screen 600 may include, for example, From “Pqrs” to current (Wxyz). There was a decrease in Order ID mainly driven by a decrease in Order ID of Vegetables (2,095,60M. 62.81%), Office Supplies (1,942.14M, 68.78%) and Snacks (1,419,70M, 91.52%). However, Household (952, 65M, 187,65%), Cereal (152.66M, 6.70%) and Cosmetics (138,44M, 11.37%) saw an increase in Order ID offsetting the overall decline. The previous statement shows the system capability to give analysis for an event and support it with details via language. In current period (Pqrs) Fruits has no records of Order ID but for pqr-stuv the Order ID was 1,691.05M. In Pqrs Personal Care and Baby Food have no records of Order ID but for current Period (Pqrs) the aggregated Order ID of these Items Type(S) is 1,408.63M. The previous statement shows another capability of the system in terms of finding patterns and events highlighting events which are not following that particular pattern.

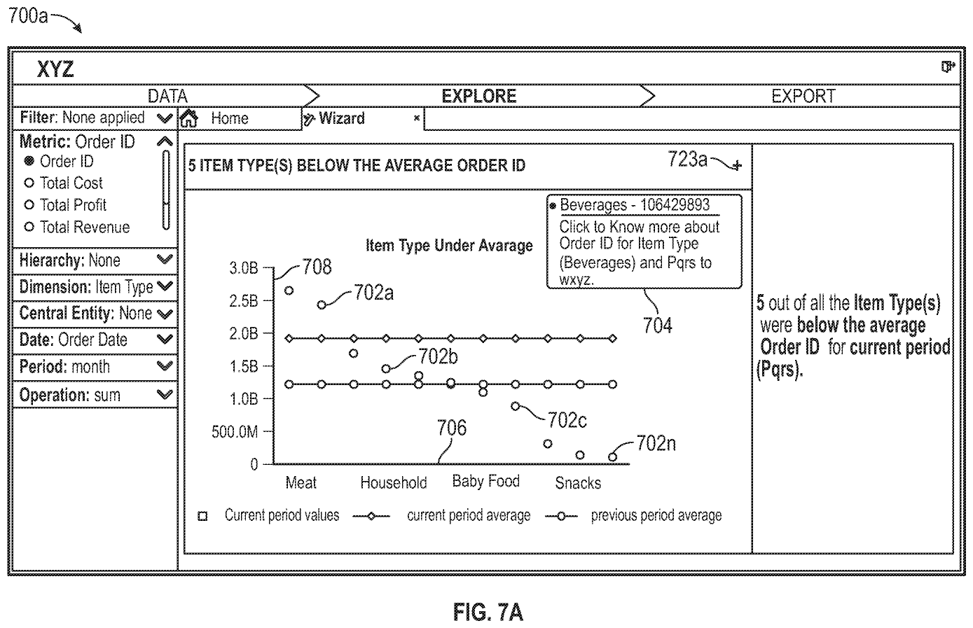

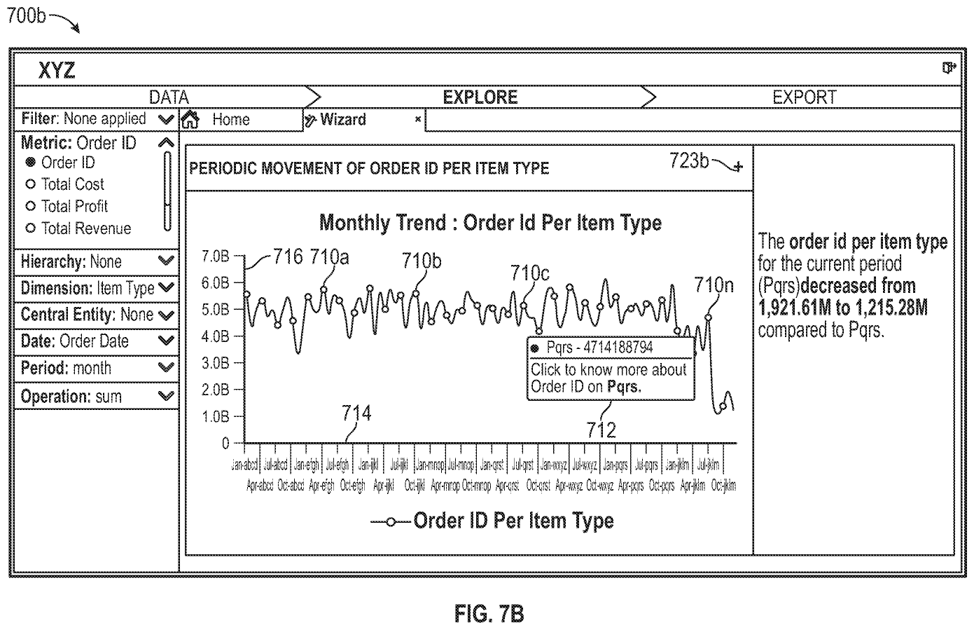

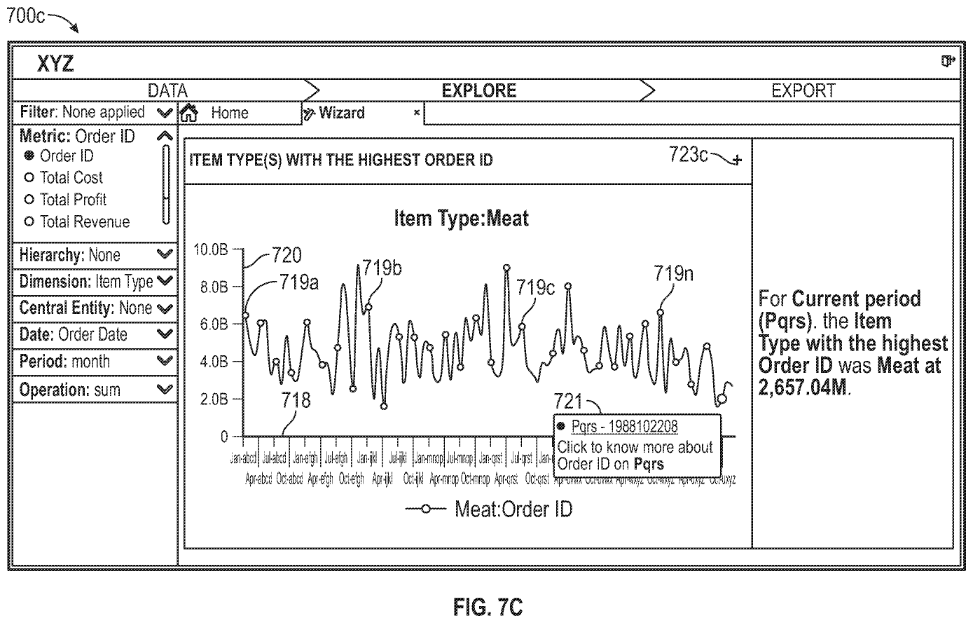

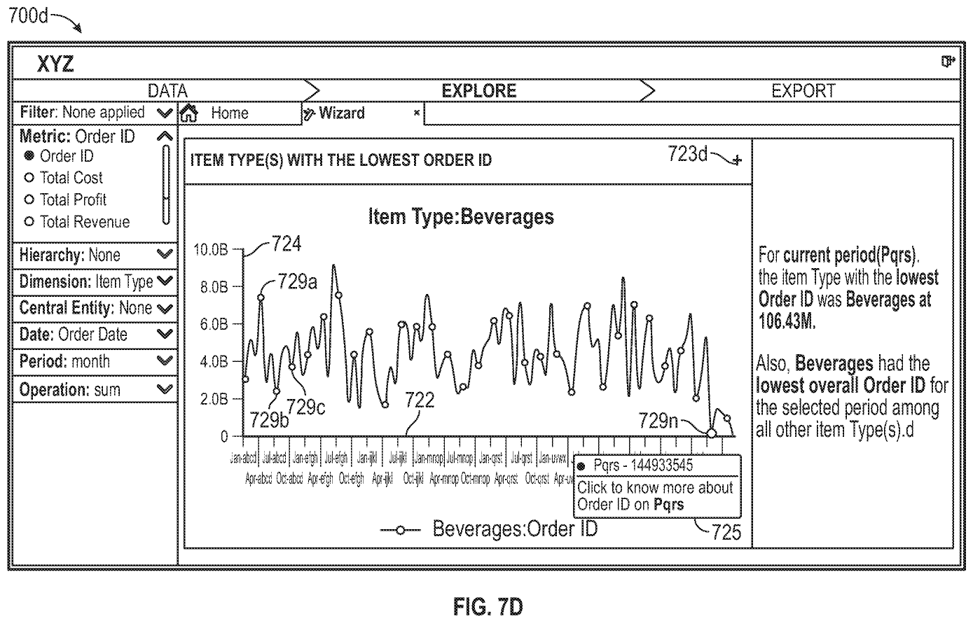

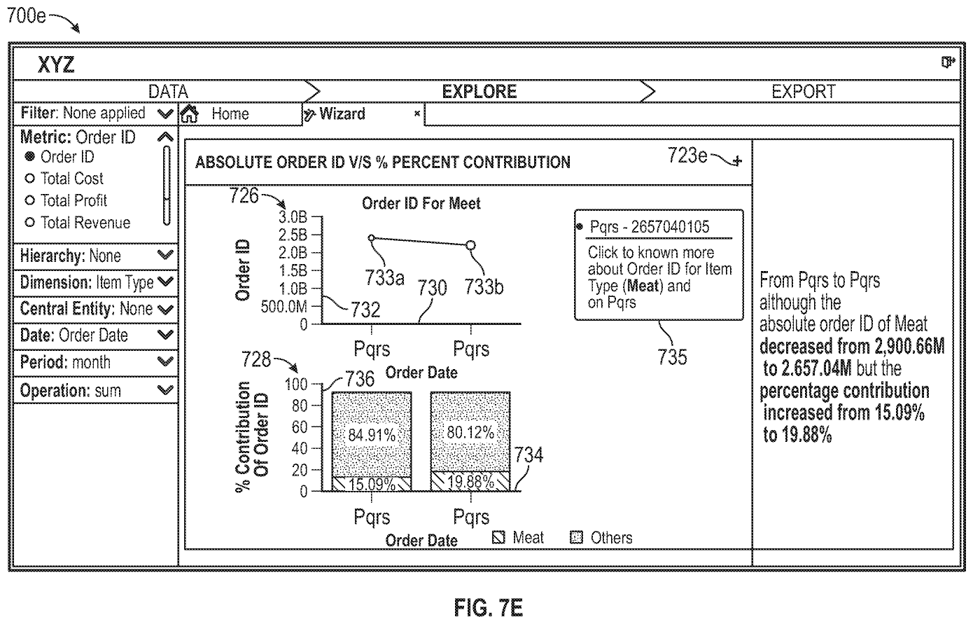

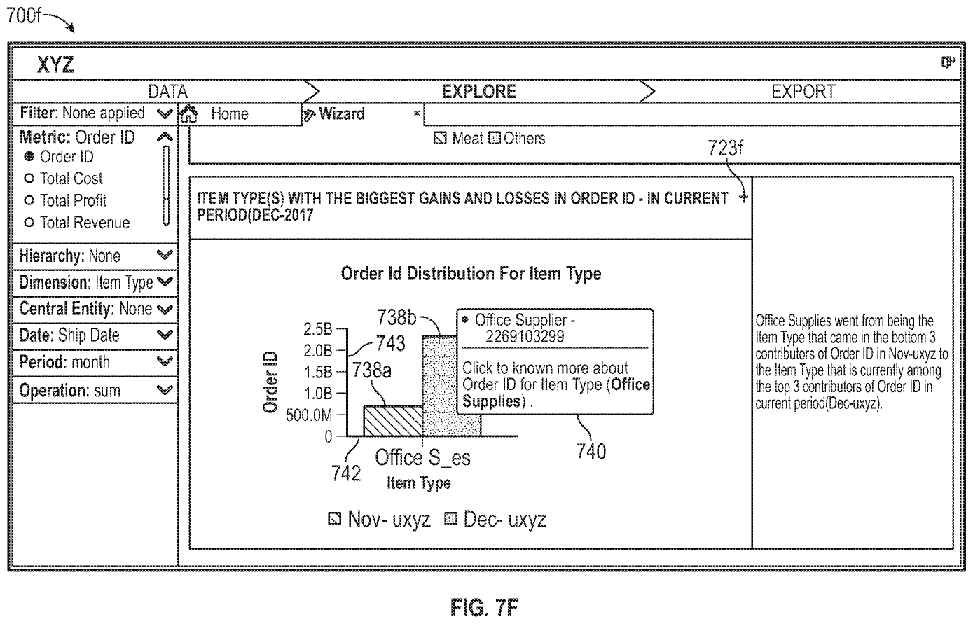

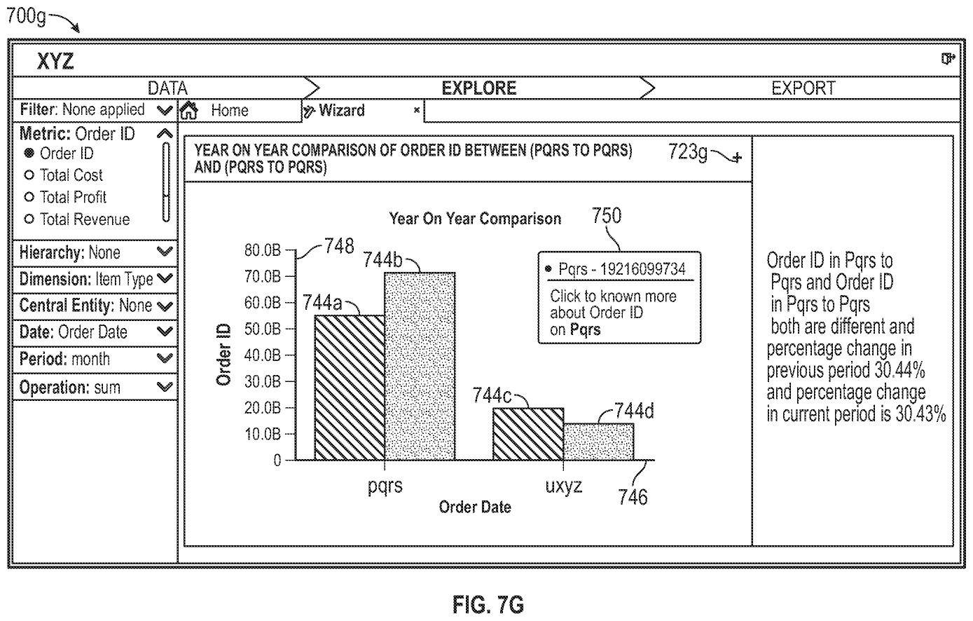

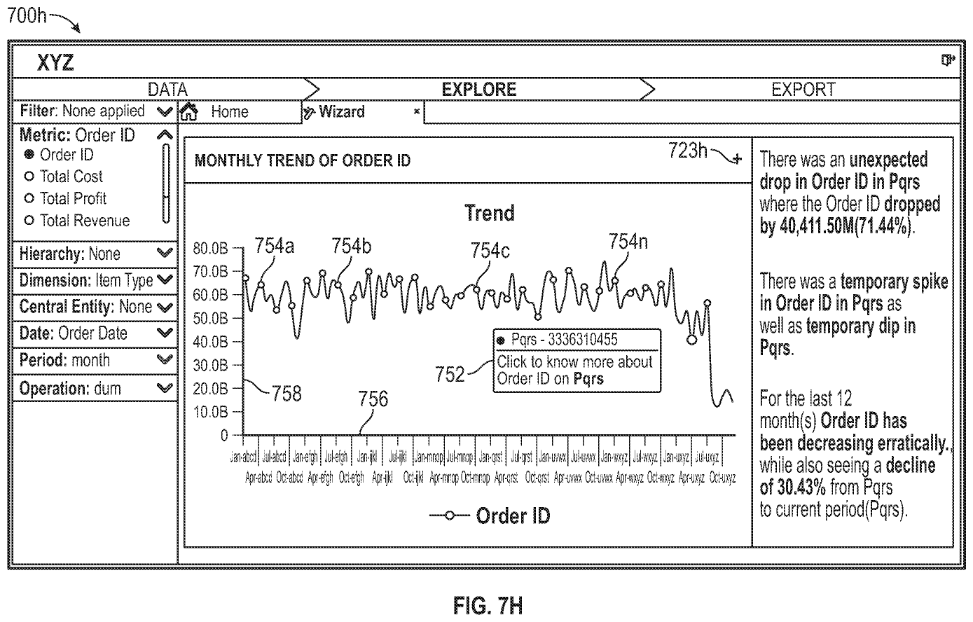

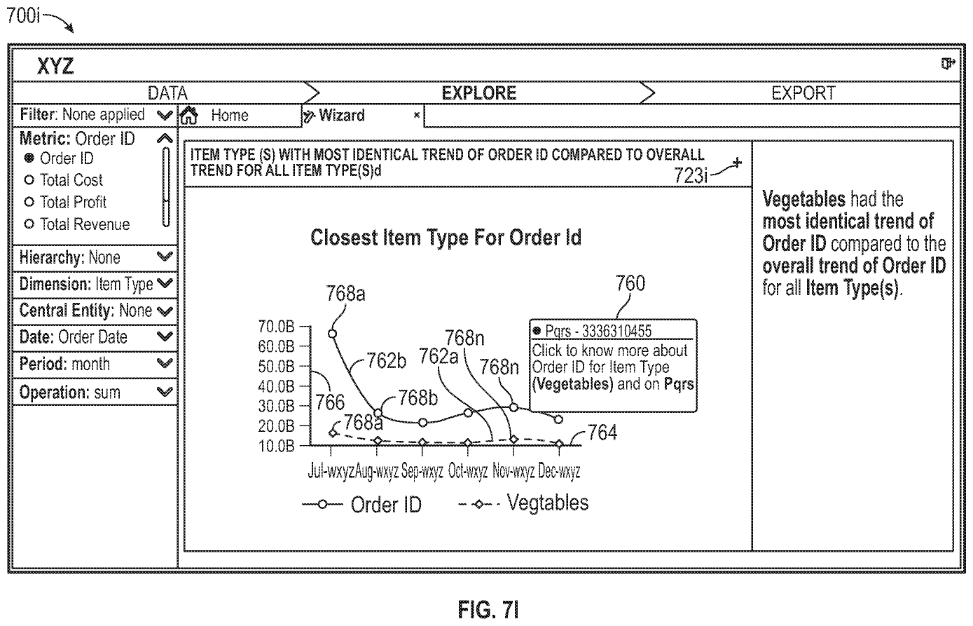

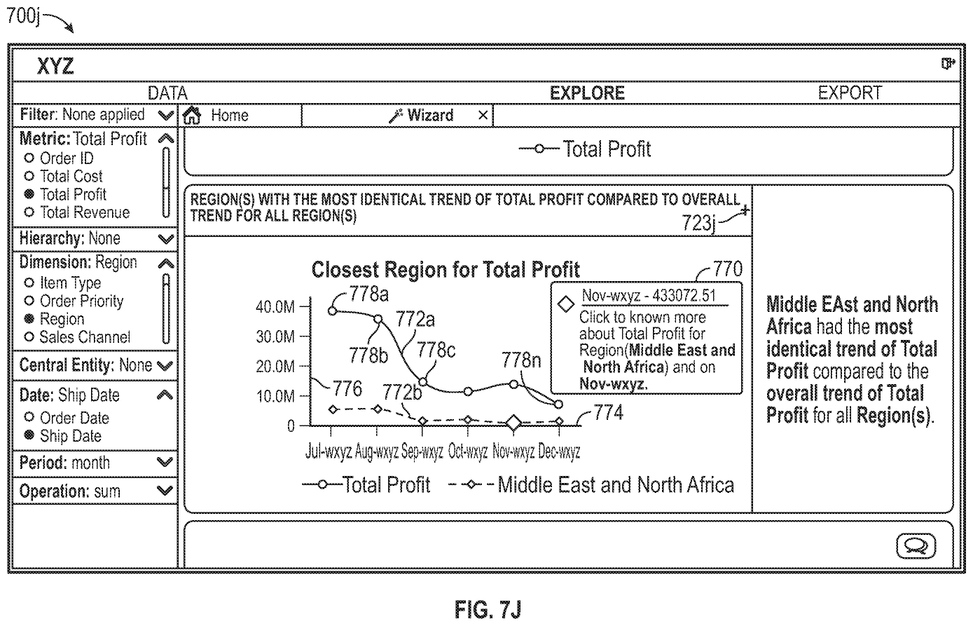

Referring to FIG. 7A is an example diagram 700a depicting another exemplary graph screen, in accordance with one or more exemplary embodiments. The exemplary graph screen 700a may include an item type(s) below the average order id graph. The item type(s) below the average order id graph 700a may include the export card option 723a, bubbles 702a, 702b, 702c . . . 702n, the screen 704, the items 706 on X-axis, the order ids 708 on Y-axis. The screen 704 may be displayed on the computing device 102 after moving mouse cursor on at least one bubble from the bubbles 702a, 702b, 702c . . . 702n. The screen 704 may include average order id for item type (for example, beverages). Market share pie chart visualizations may be displayed on the computing device 102 after selecting the at least one bubble from the bubbles 702a, 702b, 702c . . . 702n. The market share pie chart visualizations may have a drilldown view for the item type. The drilldown view may allow the user to leverage user preference and learn over it to give more meaningful insights by changing the weightages coming in to the insight generator 110. The items 706 on X-axis may include, but not limited to, meat, household, baby food snacks, and so forth. The order ids 708 on Y-axis may include, but not limited to, 0, 500.0M, 1.0B, 1.5B, 2.0B, 2.5B, 3.0B, 3.5B, and so forth. The X-axis 706 may include order items and the Y-axis may include order Id. If the user selects the export card option 723a, then the exemplary graph screen 700a may be emphasized on the computing device 102 and then the export option 306 displays the exemplary graph screen 700a separately on the computing device 102. The exemplary graph screen 700a may include, for example, 5 out of all the Item Type(s) were below the average Order ID for the current period (Pqrs).

Referring to FIG. 7B is an example diagram 700b depicting another exemplary graph screen, in accordance with one or more exemplary embodiments. The exemplary graph screen 700b may include a periodic movement of order id per item type graph. The periodic movement of order id per item type graph 700b may include the export card option 723b, the bubbles 710a, 710b, 710c . . . 710n, the screen 712, monthly trend of items 714 on X-axis, and order id 716 on Y-axis. The screen 712 may be displayed on the computing device 102 after moving mouse cursor on at least one bubble from the bubbles 710a, 710b, 710c . . . 710n. The screen 712 includes order id based on the monthly trend. Market share pie chart visualizations may be displayed on the computing device 102 after selecting the at least one bubble from the bubbles 710a, 710b, 710c . . . 710n. The market share pie chart visualizations may have a drilldown view for the item type. The drilldown view may allow the user to leverage user preference and learn over it to give more meaningful insights by changing the weightages coming in to the insight generator 110. The monthly trend of items 714 on X-axis may include Jan-pqrs, Feb-wxyz, mar-pqrs, and so forth. The order id 716 on Y-axis may include, but not limited to, 0.0B, 1.0B, 2.0B, 3.0B, 4.0B, 5.0B, 6.0B, 7.0B, and so forth. If the user selects the export card option 723b, then the exemplary graph screen 700b may be emphasized on the computing device 102 and then the export option 306 displays the exemplary graph screen 700b separately on the computing device 102. The exemplary graph screen 700a may include, for example, the order id per item type for the current period (Pqrs) decreased from 1,921.61M to 1,215.28M compared to Pqrs.

Referring to FIG. 7C is an example diagram 700c depicting another exemplary graph screen, in accordance with one or more exemplary embodiments. The exemplary graph screen 700c may include an item type(s) with the highest order id graph. Here, the item type(s) may include, but not limited to, meat, and so forth. The exemplary graph screen 700c may include the export card option 723c, the current period of highest order id 718 on X-axis, highest order id of the particular item 720 on Y-axis, the bubbles 719a, 719b, 719c . . . 719n, and a screen 721. The current period 718 on X-axis may include Jan-pqrs, Feb-wxyz, mar-pqrs, and so forth. The highest order id of the particular item 720 on Y-axis may include, but not limited to, 2.0B, 4.0B, 6.0B, 8.0B, 10.0B and so forth. The screen 721 may be displayed on the computing device 102 after moving mouse cursor on at least one bubble from the bubbles 719a, 719b, 719c . . . 719n. The screen 721 may include more details about order id. The market share pie chart visualizations may be displayed on the computing device 102 after selecting the at least one bubble from the bubbles 719a, 719b, 719c . . . 719n. The market share pie chart visualizations may have a drilldown view for the item type. The drilldown view may allow the user to leverage user preference and learn over it to give more meaningful insights by changing the weightages coming in to the insight generator 110. If the user selects the export card option 723c, then the exemplary graph screen 700c may be emphasized on the computing device 102 and then the export option 306 displays the exemplary graph screen 700c separately on the computing device 102.

Referring to FIG. 7D is an example diagram 700d depicting another exemplary graph screen, in accordance with one or more exemplary embodiments. The exemplary graph screen 700d may include an item type(s) with the lowest order id graph. The exemplary graph screen 700d may include the export card option 723d, the current period of lowest order id on X-axis 722, the lowest order id of the particular item 724 on Y-axis, the bubbles 729a, 729b, 729c . . . 729n, and the screen 725. The current period of lowest order id 722 on X-axis may include, but not limited to, Jan-pqrs, Feb-wxyz, mar-pqrs, and so forth. The lowest order id of the particular item 724 on Y-axis may include, but not limited to, 2.0B, 4.0B, 6.0B, 8.0B, 10.0B and so forth. The screen 725 may be displayed on the computing device 102 after moving the mouse cursor on at least one bubble from the bubbles 729a, 729b, and 729c . . . 729n. The screen 725 may include the current period of the item type with the lowest order ID. The market share pie chart visualizations may be displayed on the computing device 102 after selecting the at least one bubble from the bubbles 729a, 729b, 729c . . . 729n. The market share pie chart visualizations may have a drilldown view for the item type. The drilldown view may allow the user to leverage user preference and learn over it to give more meaningful insights by changing the weightages coming in to the insight generator 110. If the user selects the export card option 723d, then the exemplary graph screen 700d may be emphasized on the computing device 102 and then the export option 306 displays the exemplary graph screen 700d separately on the computing device 102.

Referring to FIG. 7E is an example diagram 700e depicting another exemplary graph screen, in accordance with one or more exemplary embodiments. The exemplary graph screen 700e may include an absolute order vs percentage contribution graph. The exemplary graph screen 700e may include the export card option 700e, an absolute order ID graph 726, and a percentage contribution graph 728. The absolute order id graph 726 may include order id 730 on X-axis, an order date 732 on Y-axis, the bubbles 733a, 733b, 733c . . . 733n, and the screen 735. The order id 730 on X-axis may include, but not limited to, 0, 500.0M, 1.0B, 1.5B, 2.0B, 2.5B, 3.0B, and so forth. The order date 732 on Y-axis may include, but not limited to, Nov-pqrs, Dec-wxyz, and so forth. The screen 735 may be displayed on the computing device 102 after moving the mouse cursor on the at least one bubble from the bubbles 733a, 733b, 733c . . . 733n. The screen 735 may include current period of order ID for item type. The market share pie chart visualizations may be displayed on the computing device 102 after selecting the at least one bubble from the bubbles 733a, 733b, 733c . . . 733n. The market share pie chart visualizations may have a drilldown view for the item type. The drilldown view may allow the user to leverage user preference and learn over it to give more meaningful insights by changing the weightages coming in to the insight generator 110. The percentage contribution graph 728 may include the current period of item 734 on X-axis, and the percentage contribution of order id 736 on Y-axis. The current period of item 734 on X-axis may include, but not limited to, Nov-pqrs, Dec-pqrs, and so forth. The percentage contribution of order id 736 on Y-axis may include, but not limited to, 0, 20, 40, 60, 80, 100, and so forth. If the user selects the export card option 723e, then the exemplary graph screen 700e may be emphasized on the computing device 102 and then the export option 306 displays the exemplary graph screen 700e separately on the computing device 102.

Referring to FIG. 7F is an example diagram 700f depicting another exemplary graph screen, in accordance with one or more exemplary embodiments. The exemplary graph screen 700f may include an item type with the biggest gains and losses in order id graph—in current period. The exemplary graph screen 700f may include an order ID distribution for item type. The item type(s) with the biggest gains and losses in order id graph 700f may include the export card option 723f, rectangular bars 738a-738b, the screen 740, the office supplies 742 on X-axis, the order Ids 743 on Y-axis. The office supplies screen 740 may be displayed on the computing device 102 after moving the mouse cursor on at least one rectangular bar from the rectangular bars 738a-738b. The screen 740 may include office supplier order id and more about order id details. The market share pie chart visualizations may be displayed on the computing device 102 after selecting the at least one rectangular bar from the rectangular bars 738a, 738b, 738c . . . 738n. The market share pie chart visualizations may have a drilldown view for the item type. The drilldown view may allow the user to leverage user preference and learn over it to give more meaningful insights by changing the weightages coming in to the insight generator 110. The exemplary graph screen 700f may include office supplies went from being the Item Type that came in the bottom contributors of Order ID in a particular period to the Item Type that is currently among the top contributors of Order ID in current period. The office supplies 742 on X-axis may include office supplies being the item type. The order Ids 743 on Y-axis may include, but not limited to, 0, 500.0M, 1.0B, 1.5B, 2.0B, 2.5B, and so forth. If the user selects the export card option 723f, then the exemplary graph screen 700f may be emphasized on the computing device 102 and then the export option 306 displays the exemplary graph screen 700f separately on the computing device 102. The exemplary graph screen 700f may include, for example, office supplies went from being the Item Type that came in the bottom 3 contributors of Order ID in Nov-pqrs to the Item Type that is currently among the top 3 contributors of Order ID in current period (Dec-pqrs). For example, the exemplary graph screen 700f may include, for example, office Supplies went from being the Item Type that came in the bottom 3 contributors of Order ID in Nov-pqrs to the Item Type that is currently among the top 3 contributors of Order ID in current period (Dec-pqrs).

Referring to FIG. 7G is an example diagram 700g depicting another exemplary graph screen, in accordance with one or more exemplary embodiments. The exemplary graph screen 700g may include year on year comparison graph. The year on year comparison graph 700g may include the export card option 723g, rectangular bars 744a, 744b, 744c, 744d, and an order date 746 on X-axis, an Order Id 748 on Y-axis, and the screen 750. The screen 750 may be displayed on the computing device 102 after moving the mouse cursor on at least one rectangular bar from the rectangular bars 744a, 744b, 744c, and 744d. The screen 750 may include percentage change in the previous period and percentage change in current period. The market share pie chart visualizations may be displayed on the computing device 102 after selecting the at least one rectangular bar from the rectangular bars 744a, 744b, 744c . . . 744n. The market share pie chart visualizations may have a drilldown view for the item type. The drilldown view may allow the user to leverage user preference and learn over it to give more meaningful insights by changing the weightages coming in to the insight generator 110. The order date 746 on X-axis may include the ship date of the items. The order Id 748 on Y-axis may include, but not limited to, 10.0B, 20.0B, 30.0B, 40.0B, 50.0B, 60.0B, 70.0B, 80.0B, and so forth. If the user selects the export card option 723d, then the exemplary graph screen 700g may be emphasized on the computing device 102 and then the export option 306 displays the exemplary graph screen 700g separately on the computing device 102. The exemplary graph screen 700g may include, for example, Order ID in Pqrs to Pqrs and Order ID in Pqrs to Pqrs both are different and percentage change in the previous period 30.44% and percentage change in current period is 30.43%.

Referring to FIG. 7H is an example diagram 700h depicting another exemplary graph screen, in accordance with one or more exemplary embodiments. The exemplary graph screen 700h may include monthly trend graph of order id. The exemplary graph screen 700h may include the export card option 723h, the screen 752, bubbles 754a, 754b, 754c . . . 754n, years 756 on X-axis, order ids 758 on y-axis. The screen 752 may be displayed on the computing device 102 after moving the mouse cursor on at least one bubble from the bubbles 754a, 754b, 754c . . . 754n. The market share pie chart visualizations may be displayed on the computing device 102 after selecting the at least one bubble from the bubbles 754a, 754b, and 754c . . . 754n. The market share pie chart visualizations may have a drilldown view for the item type. The drilldown view may allow the user to leverage user preference and learn over it to give more meaningful insights by changing the weightages coming in to the insight generator 110. Years 756 on X-axis may include, but not limited to, Jan-abcd, Apr-pqrs, Jul-abcd, Oct-wxyz, and so forth. The order ids 758 on Y-axis may include, but not limited to, 10.0B, 20.0B, 30.0B, 40.0B, 50.0B, 60.0B, 70.0B, 80.0B and so forth. If the user selects the export card option 723h, then the exemplary graph screen 700h may be emphasized on the computing device 102 and then the export option 306 displays the exemplary graph screen 700h separately on the computing device 102. The exemplary graph screen 700h may include, for example, there was an unexpected drop in Order ID in Pqrs where the Order ID dropped by 40,411.50M (71.44%). There was a temporary spike in Order ID in Pqrs as well as temporary dip in Pqrs. For the last 12 month(s) Order ID has been decreasing erratically. While also seeing a decline of 30.43% from Pqrs to current period (Pqrs).

Referring to FIG. 7I is an example diagram 700i depicting another exemplary graph screen, in accordance with one or more exemplary embodiments. The exemplary graph screen 700i may include implementation of an item type with the most identical trend of order ID compared to overall trend for all items. The exemplary graph screen 700i may include a closest item type for order Id graph. The closest item type for order Id graph 700i may include the export card option 723i, the screen 760, vegetables curve 762a, order Id curve 762b, months on X-axis 764, order Ids 766 on y-axis, bubbles 768a, 768b, 768c . . . 768n. The screen 760 may be displayed on the computing device 102 after moving mouse cursor on at least one bubble from the bubbles 768a, 768b, and 768c . . . 768n on the vegetables curve 762a or the order Id curve 762b. The market share pie chart visualizations may be displayed on the computing device 102 after selecting the at least one bubble from the bubbles 768a, 768b, 768c . . . 768n. The market share pie chart visualizations may have a drilldown view for the item type. The drilldown view may allow the user to leverage user preference and learn over it to give more meaningful insights by changing the weightages coming in to the insight generator 110. The months on X-axis 764 may include, but not limited to, Jul-abcd, Aug-abcd, Sept-abd, Oct-abcd, Nov-abcd, Dec-abcd, and so forth. The order Ids 766 on y-axis may include, but not limited to, 0, 10.0B, 20.0B, 30.0B, 40.0B, 50.0B, 60.0B, and so forth. If the user selects the export card option 723i, then the exemplary graph screen 700i may be emphasized on the computing device 102 and then the export option 306 displays the exemplary graph screen 700i separately on the computing device 102. The exemplary graph screen 700i may include, for example, vegetables had the most identical trend of Order ID compared to the overall trend of Order ID for all Item Type(s).

Referring to FIG. 7J is an example diagram 700i depicting another exemplary graph screen, in accordance with one or more exemplary embodiments. The exemplary graph screen 700j may include implementation of a region(s) with the most identical trend of total profit compared to overall trend for all region(s). The exemplary graph screen 700j may include a closest region for total profit graph. The exemplary graph screen 700j may include the export card option 723j, the screen 770, the total profit curve 772a, Middle East and North Africa curve 772b, months on X-axis 774, order IDs 776 on Y-axis, and the bubbles 778a, 778b, 778c . . . 778n. The screen 770 may be displayed on the computing device 102 after moving the mouse cursor on the at least one bubble from the bubbles 778a, 778b, and 778c . . . 778n on the total profit curve 772a, Middle East and North Africa curve 772b. The market share pie chart visualizations may be displayed on the computing device 102 after selecting the at least one bubble from the bubbles 778a, 778b, 778c . . . 778n. The market share pie chart visualizations may have a drilldown view for the item type. The drilldown view may allow the user to leverage user preference and learn over it to give more meaningful insights by changing the weightages coming in to the insight generator 110. The months on X-axis 774 may include, but not limited to, Jul-abcd, Aug-abcd, Sept-abd, Oct-abcd, Nov-abcd, Dec-abcd, and so forth. The order Ids 776 on y-axis may include, but not limited to, 0, 10.0M, 20.0M, 30.0M, 40.0M, 50.0M, 60.0M, and so forth. If the user selects the export card option 723j, then the exemplary graph screen 700j may be emphasized on the computing device 102 and then the export option 306 displays the exemplary graph screen 700j separately on the computing device 102. The exemplary graph screen 700j may include, for example, Middle East and North Africa had the most identical trend of Total Profit compared to the overall trend of Total Profit for all Region(s). Regions Middle East and North Africa have the most similar trend to Total Profit. The system figured out trends for each Region and came up with an insight by finding the most correlated Region to overall trend of Total Profit. Finding patterns and similarity between them and deciding which ones to show as an insight act as another capability of the system.

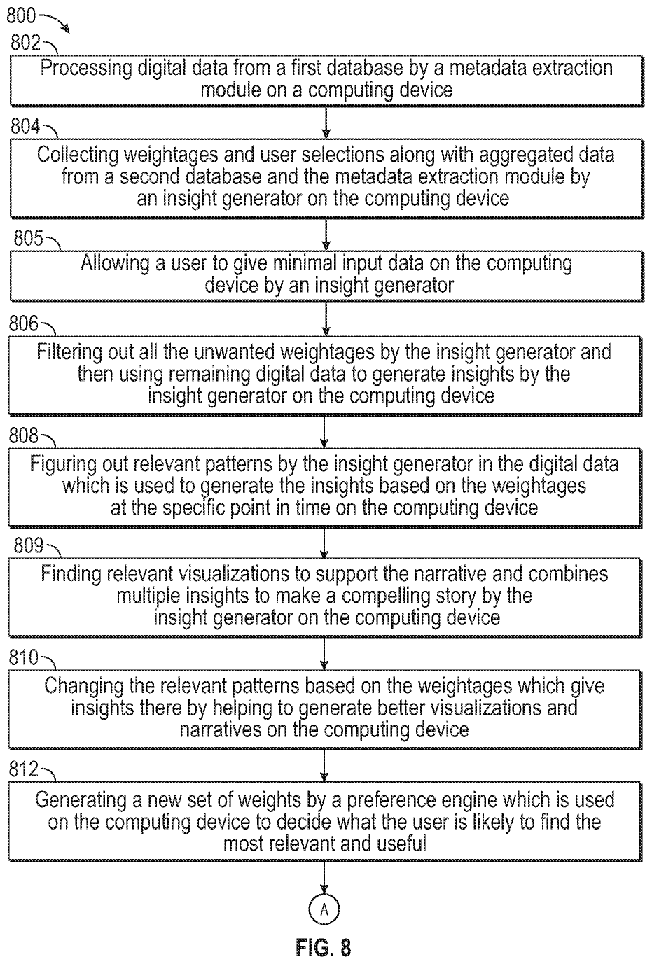

Referring to FIG. 8 is a flow diagram 800 depicting a method for generating dynamic visualizations and narrations of digital data, in accordance with one or more exemplary embodiments. The method 800 may be carried out in the context of the details of FIG. 1, FIG. 2, FIG. 3, FIG. 4, FIG. 5A-FIG. 5G, FIG. 6, and FIG. 7A-FIG. 7J. However, the method 800 may also be carried out in any desired environment. Further, the aforementioned definitions may equally apply to the description below.

The method commences at step 802, the digital data from the first database is processed by the metadata extraction module on the computing device. Thereafter, at step 804, the insight generator collects weightages and user selections along with aggregated data from the metadata extraction module and the first database on the computing device. Thereafter, at step 805, the insight generator allows the user to give minimal input data on the computing device. Where the insight generator may/may not be required the input data but their presence help the insight generator to show more relevant and precise insights. Thereafter, at step 806, the insight generator filters out all the unwanted weightages and then uses remaining digital data to generate insights by the insight generator on the computing device. Thereafter, at step 808, the insight generator figures out relevant patterns in the digital data which is used to generate the insights based on the weightages at the specific point in time on the computing device. Thereafter, at step 809, the insight generator finds relevant visualizations to support the narrative and combines multiple insights to make a compelling story on the computing device. Thereafter, at step 810, the insight generator changes the relevant patterns based on the weightages which give insights thereby helping to generate better visualizations and narratives on the computing device. Thereafter, at step 812, the preference engine generates a new set of weights which is used on the computing device to decide what the user is likely to find the most relevant and useful. Thereafter, at step 814, the preference engine tailors the new set of weights to that specific user and that data so no further filtering is needed. Thereafter, at step 816, the reducer collects account of user inputs and the weights from the preference engine on the computing device. Thereafter, at step 818, the reducer determines what insight is relevant enough to be shown to the user based on the user inputs and the weights on the computing device. Thereafter, at step 820, the visualization generation module generates the visualizations and appropriate narratives on the computing device using the output of the reducer. Thereafter, at step 822, the story generator places the visualizations and appropriate narratives such that they make the most sense to the user as well as flow like a seamless story on the computing device. Thereafter, at step 824, the story generator decides which insight follows another or when insights need to be clubbed together and appropriately changes the language to make it look like an individual insight. Thereafter, at step 826, the story engine displays the individual insights as an output to the user with the help of visualizations and narratives on the computing device.

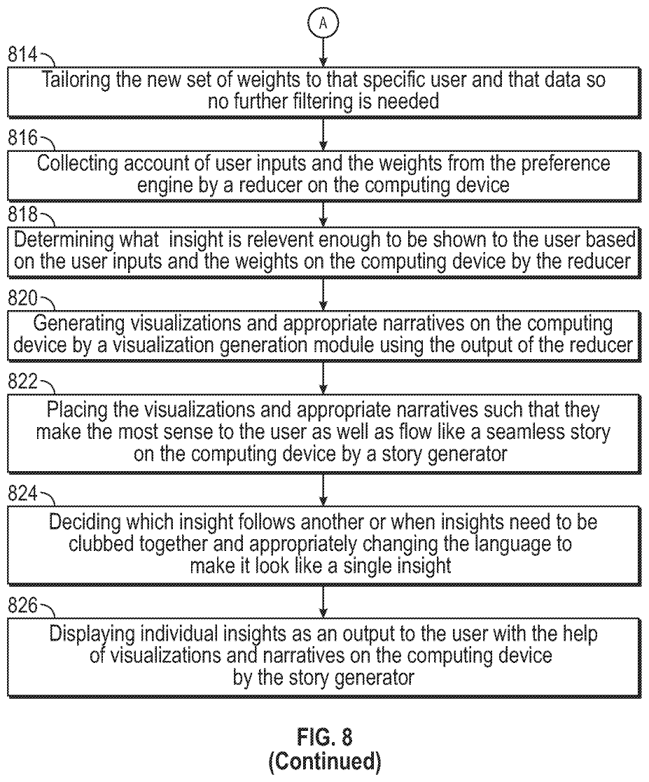

Referring to FIG. 9 is a flow diagram 900 depicting a method for updating components of the insight generator in real time on the computing device, in accordance with one or more exemplary embodiments. The method 900 may be carried out in the context of the details of FIG. 1, FIG. 2, FIG. 3, FIG. 4, FIG. 5A-FIG. 5G, FIG. 6, FIG. 7A-FIG. 7I, and FIG. 8. However, the method 900 may also be carried out in any desired environment. Further, the aforementioned definitions may equally apply to the description below.

Pull out relevant insights on the computing device for each individual user by leveraging past user actions or user profiles and generates the language in a way that every insight seems connected to a central theme/story, at step 902. Thereafter, at step 904, the insight generator updates the lot of attributes on the basis of a reward based learning on the computing device, wherein the rewards are in terms of what the user likes/selects with respect to the visualizations and narratives. Thereafter at step 906, the components of the insight generator update in real time by the data in terms of updating the metadata extraction module, preference engine and story generator on the computing device. Thereafter, at step 908, the feedback provides back to the story generator which updates the way it generates the flow and connects the insights.

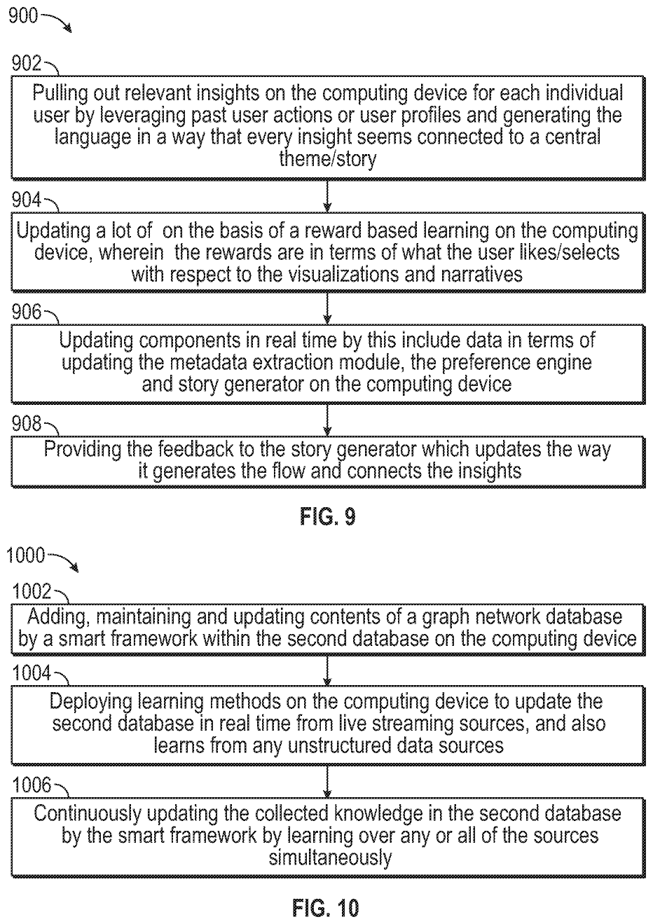

Referring to FIG. 10 is a flow diagram 1000 depicting a method for continuously updating the collected knowledge in the second database on the computing device, in accordance with one or more exemplary embodiments. The method 1000 may be carried out in the context of the details of FIG. 1, FIG. 2, FIG. 3, FIG. 4, FIG. 5A-FIG. 5G, FIG. 6, and FIG. 7A-FIG. 7J, FIG. 8, and FIG. 9. However, the method 1000 may also be carried out in any desired environment. Further, the aforementioned definitions may equally apply to the description below.

The smart framework adds, maintains and updates the contents of a graph network database within the second database on the computing device, at step 1002. Thereafter, at step 1004, deploy learning methods on the computing device to update the second database in real time from live streaming sources, and also learns from any unstructured data sources. Thereafter, at step 1006, the smart framework continuously updates the collected knowledge in the second database by learning over any or all of the sources simultaneously.

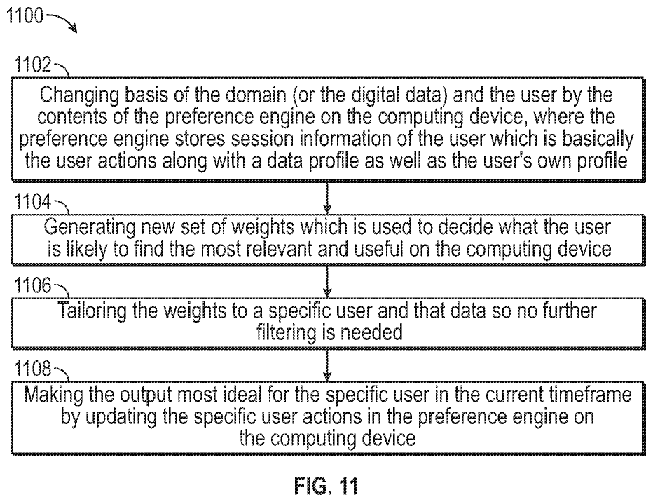

Referring to FIG. 11 is a flow diagram 1100 depicting a method for making the output most ideal for the user in the current timeframe on the computing device, in accordance with one or more exemplary embodiments. The method 1100 may be carried out in the context of the details of FIG. 1, FIG. 2, FIG. 3, FIG. 4, FIG. 5A-FIG. 5G, FIG. 6, FIG. 7A-FIG. 7J, FIG. 8, FIG. 9, and FIG. 10. However, the method 1100 may also be carried out in any desired environment. Further, the aforementioned definitions may equally apply to the description below.

The contents of the preference engine changes basis of the domain (or the digital data) and the user on the computing device, where the preference engine stores session information of the user which is basically the user actions along with a data profile as well as the user's own profile, at step 1102. Thereafter, at step 1104, the preference engine generates the new set of weights which is used to decide what the user is likely to find the most relevant and useful on the computing device. Thereafter, at step 1106, the preference engine tailors the weights to a specific user and data so no further filtering is needed. Thereafter, at step 1108, the preference engine makes the output most ideal for the specific user in the current timeframe by updating the specific user actions in the preference engine on the computing device.

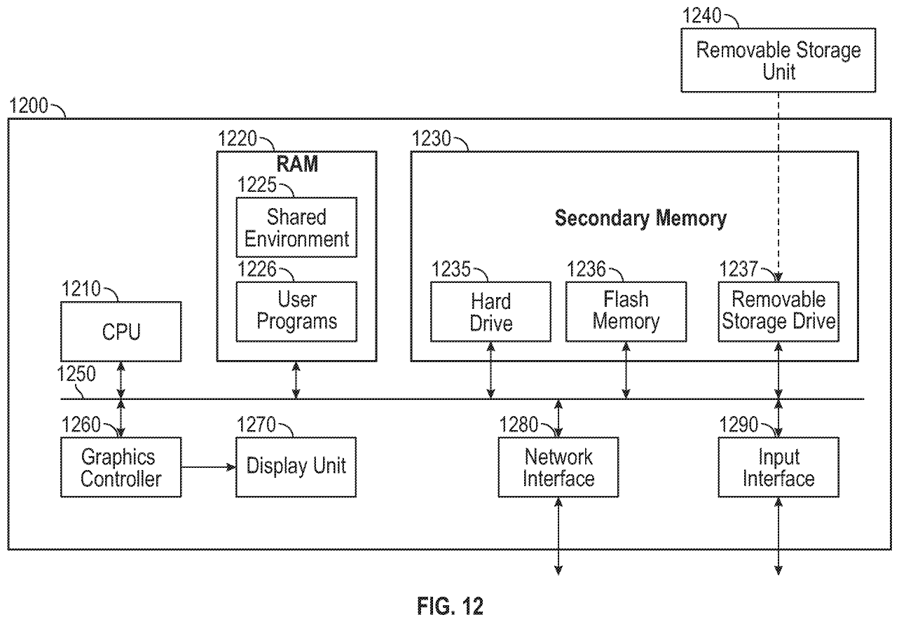

Referring to FIG. 12 is a block diagram 1200 illustrating the details of a digital processing system 1200 in which various aspects of the present disclosure are operative by execution of appropriate software instructions. The Digital processing system 1200 may correspond to the computing device 102 (or any other system in which the various features disclosed above can be implemented).

Digital processing system 1200 may contain one or more processors such as a central processing unit (CPU) 1210, random access memory (RAM) 1220, secondary memory 1230, graphics controller 1260, display unit 1270, network interface 1280, and input interface 1290. All the components except display unit 1270 may communicate with each other over communication path 1250, which may contain several buses as is well known in the relevant arts. The components of FIG. 12 are described below in further detail.

CPU 1210 may execute instructions stored in RAM 1220 to provide several features of the present disclosure. CPU 1210 may contain multiple processing units, with each processing unit potentially being designed for a specific task. Alternatively, CPU 1210 may contain only a single general-purpose processing unit.

RAM 1220 may receive instructions from secondary memory 1230 using communication path 1250. RAM 1220 is shown currently containing software instructions, such as those used in threads and stacks, constituting shared environment 1225 and/or user programs 1226. Shared environment 1225 includes operating systems, device drivers, virtual machines, etc., which provide a (common) run time environment for execution of user programs 1226.

Graphics controller 1260 generates display signals (e.g., in RGB format) to display unit 1270 based on data/instructions received from CPU 1210. Display unit 1270 contains a display screen to display the images defined by the display signals. Input interface 1290 may correspond to a keyboard and a pointing device (e.g., touch-pad, mouse) and may be used to provide inputs. Network interface 1280 provides connectivity to a network (e.g., using Internet Protocol), and may be used to communicate with other systems (such as those shown in FIG. 1) connected to the network 104.

Secondary memory 1230 may contain hard drive 1235, flash memory 1236, and removable storage drive 1237. Secondary memory 1230 may store the data software instructions (e.g., for performing the actions noted above with respect to the Figures), which enable digital processing system 1200 to provide several features in accordance with the present disclosure.

Some or all of the data and instructions may be provided on removable storage unit 1240, and the data and instructions may be read and provided by removable storage drive 1237 to CPU 1210. Floppy drive, magnetic tape drive, CD-ROM drive, DVD Drive, Flash memory, removable memory chip (PCMCIA Card, EEPROM) are examples of such removable storage drive 1237.

Removable storage unit 1240 may be implemented using medium and storage format compatible with removable storage drive 1237 such that removable storage drive 1237 can read the data and instructions. Thus, removable storage unit 1240 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1240 or hard disk installed in hard drive 1235. These computer program products are means for providing software to digital processing system 1200. CPU 1210 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1230. Volatile media includes dynamic memory, such as RAM 1220. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 1250. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for generating dynamic visualizations and narrations of digital data, comprising:
a computing device comprises a dynamic data visualization and narration module, whereby the dynamic data visualization and narration module comprises at least one first database configured to hold digital data to run analysis and a metadata extraction module configured to process the digital data on the computing device;
an insight generator configured to take a plurality of weightages from a second database and the user selections as the input along with the aggregated data, the insight generator also configured to filter out all unwanted weightages based on the data's domain and uses the remaining data to generate a plurality insights from the data on the computing device;
a preference engine configured to store session information of the user, along with the Data profile as well as the user's own profile and also generates a new set of weights which is used to decide what the user is likely to find the most relevant and useful;
a reducer configured to take account of user inputs and weights generated at that point by the preference engine and the reducer also configured to take the account of user inputs and a combination of a component called “Preference” and the reducer is configured to decide which insight is relevant enough to be shown to the user based on a plurality of parameters, a plurality of visualizations generated on the computing device based on a plurality of dynamic factors or features of the data and a plurality of patterns in the data on which the insight is formed.

2. The system of claim 1, wherein the insight generator configured to figure out a plurality of relevant data patterns which is used to generate the plurality of insights on the basis of the weightages at that specific point in time thereby helping generate the plurality of visualizations and a plurality of narratives on the computing device.

3. The system of claim 1, wherein the preference engine is further configured to input the user actions data and keeps updating to make the output the most ideal for the specific user in the current timeframe.

4. The system of claim 1, wherein the dynamic data visualization and narration module comprises a story generator configured to decide which insight follows another based on data profile and user profile.

5. The system of claim 1, wherein the preference engine gets updated as it stores user's session information and provides feedback to the story generator which then updates the way it generates the flow and connects the plurality of insights on the computing device.

6. The system of claim 1, wherein the second database comprises a smart framework configured to add, maintain and update the contents of a graph network database.

7. The system of claim 1, wherein the graph network database comprises all worldly information which relates to any domain or any event on the computing device.

8. The system of claim 1, wherein the second database continuously updates the collected knowledge by the smart framework by learning over any or all the data sources simultaneously.

9. The system of claim 1, wherein the insight generator comprises a filter module configured to filter out all the unwanted weightages and then uses the remaining data to generate the plurality of insights from the data on the computing device.

10. The system of claim 1, wherein the dynamic data visualization and narration module further comprises a visualization generation module configured to generate the plurality of visualizations basis a lot of dynamic factors of features of the data and on the basis the plurality of patterns in the data on which the insight is formed.

11. The system of claim 10, wherein the visualization generation module configured to use the output of the reducer to generate the plurality of visualizations and appropriate narratives on the computing device.

12. The system of claim 1, wherein the dynamic data visualization and narration module comprises a natural language generation module configured to generate narrative for each graph/representation/visualization which explains the findings of the insights on the computing device.

13. A method for generating dynamic visualizations and narrations of digital data, comprising:
processing digital data from a first database by a metadata extraction module on a computing device, whereby the computing device enables an insight generator module to collect a plurality of weightages and a plurality of user selections along with aggregated data from the metadata extraction module and the first database on the computing device;
allowing a user to give minimal input data on the computing device by the insight generator, whereby the insight generator filters out all the unwanted weightages and then uses remaining digital data to generate a plurality of insights on the computing device;
figuring out relevant patterns in the digital data by the insight generator based on the plurality of weightages at the specific point in time on the computing device;
finding a plurality of relevant visualizations to support the narrative and combines the plurality of insights to make a compelling story on the computing device and the insight generator changes the plurality of relevant patterns based on the plurality of weightages which give the plurality of insights;
generating a new set of weights by a preference engine used on the computing device to decide what the user is likely to find the most relevant and useful, the preference engine tailors the new set of weights to that specific user and that data;
collecting a plurality of user inputs and the plurality of weights from the preference engine by a reducer on the computing device, whereby the computing device enables the reducer to determine what insight is relevant enough to be shown to the user based on the plurality of user inputs and the plurality of weights;
generating the plurality of visualizations appropriate narratives on the computing device by a visualization generation module using the output of the reducer;
deciding which insight follows another by a story generator or when insights need to be clubbed together and appropriately changes the language to make it look like an individual insight on the computing device; and
displaying the plurality of insights as an output to the user with the help of plurality of visualizations and narratives on the computing device.

14. The method of claim 13, wherein the story generator places the plurality of visualizations and appropriate narratives such that they make the most sense to the user as well as flow like a seamless story on the computing device.

15. The method of claim 13, wherein the computing device implements transfer learning and one-shot learning techniques to add a new domain in a second database with minimal efforts in training for the new domain.

16. The method of claim 13, wherein the computing device deploys online learning techniques to update the second database in real time from live streaming sources and also learns from any unstructured data sources such as news website, social media sites, and any third party websites.

17. A computer program product comprising a non-transitory computer-readable medium having a computer-readable program code embodied therein to be executed by one or more processors, said program code including instructions to:
process digital data from a first database by a metadata extraction module on a computing device, whereby the computing device enables an insight generator module to collect a plurality of weightages and a plurality of user selections along with aggregated data from the metadata extraction module and the first database on the computing device;
allow a user to give minimal input data on the computing device by the insight generator, whereby the insight generator filters out all the unwanted weightages and then uses remaining digital data to generate a plurality of insights on the computing device;
figuring out relevant patterns in the digital data by the insight generator based on the plurality of weightages at the specific point in time on the computing device;
find a plurality of relevant visualizations to support the narrative and combines the plurality of insights to make a compelling story on the computing device and the insight generator changes the plurality of relevant patterns based on the plurality of weightages which give the plurality of insights;
generate a new set of weights by a preference engine used on the computing device to decide what the user is likely to find the most relevant and useful, the preference engine tailors the new set of weights to that specific user and that data;
collect a plurality of user inputs and the plurality of weights from the preference engine by a reducer on the computing device, whereby the computing device enables the reducer to determine what insight is relevant enough to be shown to the user based on the plurality of user inputs and the plurality of weights;
generate the plurality of visualizations appropriate narratives on the computing device by a visualization generation module using the output of the reducer;
decide which insight follows another by a story generator or when insights need to be clubbed together and appropriately changes the language to make it look like an individual insight on the computing device; and
display the plurality of insights as an output to the user with the help of plurality of visualizations and narratives on the computing device.
